(19) United States
(12) Patent Application Publication
(10) Pub. No.: US 2026/0275194 A1
(43) Pub. Date: Sep. 17, 2026

(54) LIQUID CRYSTAL COMPOSITION AND LIQUID CRYSTAL DISPLAY DEVICE THEREOF

(71) Applicant: Jiangsu Hecheng Display Technology Co., Ltd., Nanjing (CN)

(72) Inventors: Yayun WANG, Nanjing (CN); Tengyun ZHAO, Nanjing (CN); Di HE, Nanjing (CN); Wenquan DING, Nanjing (CN); Panpan WANG, Nanjing (CN); Yafei YANG, Nanjing (CN); Dike PAN, Nanjing (CN); Huijuan DAI, Nanjing (CN); Beibei ZHU, Nanjing (CN); Rongrong LI, Nanjing (CN); Jiali LU, Nanjing (CN); Lifang YAO, Nanjing (CN)

(73) Assignee: Jiangsu Hecheng Display Technology Co., Ltd., Nanjing (CN)

(21) Appl. No.: 19/137,477

(22) PCT Filed: Dec. 13, 2023
(86) PCT No.: PCT/CN2023/138323

§ 371 Date: Jun. 10, 2025

(30) Foreign Application Priority Data
Dec. 15, 2022 (CN) 202211618551.5
Dec. 15, 2022 (CN) 202211618829.9
Dec. 15, 2022 (CN) 202211618867.4

(51) Int. Cl. C09K 19/34; C09K 19/04; C09K 19/38

(52) U.S. Cl. CPC C09K 19/3491; C09K 19/3852; C09K 2019/0448

(57) ABSTRACT

The present invention provides a liquid crystal composition and a liquid crystal display device thereof. The liquid crystal composition of the present invention comprises at least one compound of general formula P and at least one compound of general formula B. The liquid crystal composition of the present invention has a better optical anisotropy, a comparable or even higher clearing point, a better absolute value of dielectric anisotropy, a higher K value (K₁₁, K₃₃, Kₐᵥₑ), a comparable rotational viscosity, a shorter response time, a higher transmittance, a higher contrast, a longer low-temperature storage time and a larger Flicker absolute value, such that the liquid crystal display device comprising the same has a better contrast, a wider temperature range for application, a better transmittance as well as less flicker and a better screen display effect, and when applied to PSA type liquid crystal display mode, the liquid crystal composition has a smaller roughness, a better pre-tilt angle stability, a lower residue concentration and a higher VHR stability.

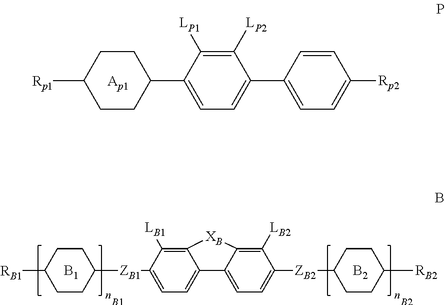

### TECHNICAL FIELD

The present invention relates to the field of liquid crystal, specifically to a liquid crystal composition and a liquid crystal display device comprising the liquid crystal composition.

### BACKGROUND ARTS

Liquid crystal displays (LCDs) have gained rapid development due to their small size, light weight, low power consumption and excellent display quality, and in particular, have been widely used in portable electronic information products. Based on the displaying mode, liquid crystal displays can be classified into the types of PC (phase change), TN (twisted nematic), STN (super twisted nematic), ECB (electrically controlled birefringence), OCB (optically compensated bend), IPS (in-plane switching), FFS (fringe field switching), VA (vertical alignment), PSA (polymer stable alignment), and the like.

A liquid crystal display device includes a nematic liquid crystal composition, and the liquid crystal composition has appropriate characteristics. An AM device having good characteristics can be obtained via improving the characteristics of the liquid crystal composition. The correlations between the characteristics of the liquid crystal composition and AM device are summarized in Table A below. The characteristics of liquid crystal composition are further described based on commercially available AM elements. The temperature range for application of the nematic phase is related to the temperature range for application of the element. The viscosity of the liquid crystal composition is related to the response time of the element. In order for the element to display a dynamic image, it is preferable that the response time of the element is short.

TABLE A
Characteristics of liquid crystal composition and AM element

| | Characteristics of liquid | |
|---|---|---|
| No. | crystal composition | Characteristics of AM element |
| 1 | wide temperature range of a | wide temperature range for |
| | nematic phase | application |
| 2 | small viscosity | short response time |
| 3 | large optical anisotropy | large contrast |
| 4 | large absolute value of | low threshold voltage, small electric |
| | dielectric anisotropy | power consumption, large contrast |
| 5 | large specific resistance | large voltage holding ratio, |
| | | large contrast |
| 6 | ultraviolet light and heat | long service life |
| | stabilities | |
| 7 | large elastic constant | large contrast, short response |
| | | time, fast response speed |

In the application of liquid crystal display devices, the impact of contrast on the visual effect is very critical. Generally speaking, the larger the contrast is, the clearer and more eye-catching the image will be, and the more vibrant and gorgeous the colors will be. In turn, if the contrast is small, the whole picture becomes gray and dull. High contrast is of great help for image clarity, detail performance, gray level performance. High contrast products have advantages in black and white contrast, clarity, integrity and so forth. Contrast also has a great impact on the display effect of dynamic video. The light-dark conversion in the dynamic image is fast, therefore, the higher the contrast is, the easier it is for the human eyes to distinguish such a conversion process.

In order to improve the response speed of liquid crystal display device, it is required to minimize the rotational viscosity of liquid crystal materials as much as possible. However, generally, a liquid crystal material with low viscosity has a low clearing point, a low optical anisotropy and the like. Therefore, when formulating the liquid crystal compositions, other performance requirements need to be considered while reducing viscosity.

According to the equation of the transmittance for IPS mode T∝|Δε|/ε_{⊥} (wherein, T represents transmittance, and “∝” represents the “inverse proportion” relationship, and ε_{⊥} represents the dielectric constant perpendicular to the direction of the molecular axis), in order to improve the transmittance of the liquid crystal, Δε of liquid crystal medium can be decreased. But in general, the adjustment range for the drive voltage of the same product is limited. In addition, the liquid crystal molecules will tilt towards the Z axis under the action of the vertical component of the edge electric field, resulting in the change of its optical anisotropy. According to the equation

$$T = {sin}^{2} ( 2 χ ) {sin}^{2} ( \frac{πΔ nd}{λ} )$$

(wherein, χ is the angle between the optical axis of the liquid crystal layer and the optical axis of the polarizer, Δn is the optical anisotropy, d is the distance between cells, and λ is the wavelength), it can be seen that effective Δn*d will affect T. In order to improve the transmittance of the positive liquid crystal, it is possible to increase Δn*d, but the retardation amount for each product is designed to be fixed.

In another aspect, based on the light leakage test of traditional IPS-LCD, the main causes of the light leakage issues of LCD device are as follows: LC scattering, rubbing uniformity, CF/TFT scattering, and polarize ability, wherein LC scattering accounts for 63% of the factors affecting light leakage performance.

According to the following equation:

$$LC Scattering ∝ \frac{d \cdot {Δ n}^{2} \cdot {( {n}_{e} + {n}_{o} )}^{2}}{{K}_{ave}} ,$$

wherein d represents the distance between liquid crystal cells, nₑ represents the refractive index of extraordinary light, nₒ represents the refractive index of ordinary light, Δn represents optical anisotropy, and Kₐᵥₑ represents average elastic constant, Kₐᵥₑ=(K₁₁+K₂₂+K₃₃)/3.

In order to improve the LC scattering of liquid crystal materials, it is required to improve the LC scattering by increasing the average elastic constant Kₐᵥₑ, and in the case of increasing Kₐᵥₑ, the light leakage of liquid crystal materials can be reduced.

In addition, the relationship between the contrast rate (CR) and the luminance (L) is as follows:

$$CR = {L}_{255} / {L}_{0} \times 100 \% ,$$

wherein L₂₅₅ is the On-state luminance, and L₀ is the Off-state luminance. It can be seen that CR is significantly affected by the change of L₀. In the Off state, L₀ has nothing to do with the dielectric of the liquid crystal molecule, but is related to the LC Scattering of the liquid crystal material itself. The smaller the LC Scattering is, the smaller the L₀ will become, and the more significantly CR will be increased.

In view of the above, common methods used to improve the contrast and transmittance may be considered from the following two aspects: (1) keeping the dielectric anisotropy Δε of the liquid crystal composition unchanged, the transmittance may be effectively improved by increasing ε_{⊥}; (2) increasing the value of the average elastic constant Kₐᵥₑ of liquid crystal composition, such that the liquid crystal molecules become more organized, have less light leakage, thereby improving the transmittance. However, the liquid crystal composition provided in the prior art has a small ratio of ε_{⊥}/Δε and a small Kₐᵥₑ value, resulting in an insufficient transmittance, a slow response speed, and a poor low-temperature storage performance. Therefore, how to provide a liquid crystal composition that can solve the above problems remains an urgent technical problem in the art.

A PSA-type liquid crystal display device is manufactured by adding a small amount (for example, 0.3 wt. %, typically, <1 wt. %) of one or more polymerizable compounds into a liquid crystal composition, ensuring that after the liquid crystal composition is filled into a liquid crystal cell, and polymerizing, usually via a UV photopolymerization, or crosslinking the polymerizable compounds in situ under a condition where liquid crystal molecules are initially aligned with or without a voltage applied between electrodes, thereby fixing the alignment of the liquid crystal molecules. With the continuous development of PSA-type liquid crystal display device, it is used in diverse classical liquid crystal displays, such as the known PSA-VA. PSA-OCB, PSA-IPS, PSA-FFS, and PSA-TN displays. In a PSA liquid crystal display, the liquid crystal composition containing the polymerizable compound(s) is positioned between two substrates. Each substrate is equipped with an electrode structure, or alternatively two electrode structures are provided on only one of the substrates, and an orthogonal polarizer is attached to the outside of the substrate. In addition, one or both substrates may contain an alignment film which is provided on the substrate or the electrode structure (if present). Like the conventional liquid crystal displays. PSA liquid crystal displays can be operated as active-matrix displays or passive-matrix displays. In the case of active-matrix displays, individual pixels are addressed by integrated, non-linear active elements, such as transistors, while in the case of passive-matrix displays, individual pixels are usually addressed by the multiplex method, as known from the prior art.

After filling the liquid crystal composition into the display device, the polymerizable compounds contained in the liquid crystal composition are polymerized or crosslinked in situ, usually by UV photopolymerization, which is achieved by exposing the liquid crystal composition to UV radiation, preferably while a voltage is applied to the electrode structures. As a result of UV exposure, the polymerized or crosslinked polymerizable compounds phase-separate from other compounds in the liquid crystal composition and form a polymer layer on the substrate surfaces, where they induce a pre-tilt angle of the liquid crystal molecules relative to the substrates. Polymerization of the polymerizable compounds preferably takes place with an applied voltage in case of PSA-VA, PSA-OCB, PSA-FFS and PSA-TN liquid crystal displays, and with or without, preferably without, an applied voltage in case of PSA-IPS displays.

Usually. UV photopolymerization in the PSA liquid crystal display production process is carried out through the following two steps.

In the first step (hereinafter also referred to as “UV1 step”), the liquid crystal composition is exposed to UV radiation emitted by a radiation source (hereinafter also referred to as “UV1 radiation”), while applying a voltage to the electrode structures, thereby generating a pre-tilt angle. A more preferred polymerizable compound should generate a smaller pre-tilt angle within the same time or a same pre-tilt angle within a shorter UV1 radiation time (i.e., a faster speed for forming pre-tilt angle), so as to improve production efficiency, shorten the tact time during batch production, and reduce costs. At the same time, the faster the speed for forming pre-tilt angle of a polymerizable compounds, the more favorable it is for the polymerizable compound to achieve complete polymerization and thereby reduce polymer residue. In order to improve the speed for forming pre-tilt angle, shorter wavelength UV1 radiation is preferred, while in order to improve the voltage holding ratio (VHR), longer wavelength UV1 radiation is preferred. Therefore, it is usually difficult to balance a faster speed for forming pre-tilt angle with a higher voltage holding ratio.

In the second step (hereinafter also referred to as “UV2 step”), the liquid crystal composition is exposed to UV radiation (hereinafter also referred to as “UV2 radiation”) without applying a voltage to the electrode structures, so as to ensure complete polymerization of any residual polymerizable compounds that did not polymerize in UV1 step. It is expected that after UV2 step, the change in pre-tilt angle should be minimized as much as possible to reduce the possibility of display unevenness in PSA type liquid crystal displays due to uneven conditions of the UV process (uneven external conditions such as light, heat, stress and the like). At the same time, the UV radiation intensity in UV2 step should be reduced to avoid or reduce negative effects such as reduced reliability or image stickiness.

In the current production of PSA type liquid crystal displays, a layer of polyimide (PI) alignment layer (referred to as PI alignment layer) needs to be coated on the glass substrate to achieve vertical alignment of liquid crystal molecules. However, this method has significant drawbacks (such as complex, complicated, and time-consuming PI coating process), as well as many other adverse effects, thereby greatly limiting the quality of liquid crystal displays. PI alignment process significantly reduces production efficiency and increases production costs. At the same time, due to the limited precision control ability of PI printing area, the deviation of PI printing area can affect the sealing performance of frame glue and the display effect of edges of narrow-bezel products, thereby greatly restricting the development of mainstream narrow-bezel products and substantially reducing the production yield. In existing technology, self alignment agents are mainly added to liquid crystal compositions to replace the use of PI alignment layers, but not all liquid crystal compositions can achieve perfect compatibility with polymerizable compounds and self-alignment agents. For example, the pre-tilt angle formation rate during UV processes is too slow, requiring extended UV irradiation time to achieve the desired pre-tilt angle, thereby reducing production efficiency; polymers and self-aligning agents exhibit excessively fast polymerization rates and poor diffusion during UV polymerization, which can easily lead to explosive polymerization, thereby resulting in a large surface roughness of polymer layer and the formation of fragmented bright spots that impair display quality of the panel; after the UV1 and UV2 steps, there may be a high residue content of polymerizable compounds and self-alignment agents, resulting in issues such as deterioration of panel image sticking (IS). At the same time, poor mutual solubility between liquid crystal compositions, polymerizable compounds, and self-aligning agents can lead to precipitation of polymerizable compounds and self-aligning agents during storage, resulting in the failure of liquid crystal performance. Meanwhile, weak rigidity of polymer networks formed after polymerization may cause structural changes in the structure of the polymer networks when PSA type liquid crystal display elements continuously display the same pattern for a long time, which in turn alter the pre-tilt angle of liquid crystal molecules and cause display defects. Large liquid crystal contact angle of the self-aligning agents slow down liquid crystal diffusion in the One Drop Filling (ODF) processes, which result in uneven concentration distribution of the self-aligning agents within the panels, thereby leading to non-uniform alignment effect or poor alignment effect in the panel corner area, ultimately causing display defects.

Furthermore, with the development of display technology, the liquid crystal display industry has more stringent requirements for the display quality of liquid crystal display, especially in the TV industry, with the general increase of the size of TVs, the LCD generation line has been increased. The difficulty of manufacturing the large-size LCD panels has also been significantly increased. Therefore, how to ensure the display quality is an urgent problem to be solved. Meanwhile, in addition to continuously optimizing the panel manufacturing process, the development of liquid crystal materials is also one of the means. Especially for PSA liquid crystal displays, the selection of liquid crystal compositions used in combination with polymerizable compounds has become a hot spot of the research.

### SUMMARY OF THE INVENTION

Objectives of Invention: In view of the defects of existing technologies, the objective of the present invention is to provide a liquid crystal composition having a better optical anisotropy, a comparable clearing point, a better absolute value of dielectric anisotropy, a higher K value (K₁₁, K₃₃, Kₐᵥₑ), a comparable rotational viscosity, a shorter response time, a higher transmittance, a higher contrast, a longer low-temperature storage time and a larger Flicker absolute value, and when applied to PSA type liquid crystal display mode, the liquid crystal composition has a smaller roughness, a better pre-tilt angle stability, a lower residue concentration and a higher VHR stability.

Further, the objective of the present invention is also to provide a liquid crystal display device comprising the above liquid crystal composition.

### Technical Solutions

To realize the above invention objectives, the present invention provides a liquid crystal composition, the liquid crystal composition comprises
at least one compound of general formula P:

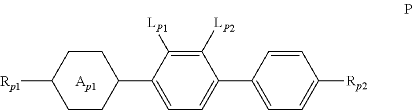

and
at least one compound of general formula B:

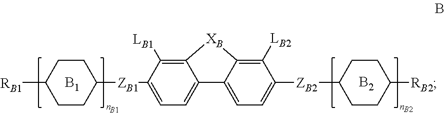

wherein,
Rₚ₁, Rₚ₂ and R_{B1} each independently represents C₁₋₁₂ (for example, C₁, C₂, C₃, C₄, C₅, C₆, C₇, C₈, C₉, C₁₀, C₁₁ or C₁₂) linear alkyl, C₃₋₁₂ (for example, C₃, C₄, C₅, C₆, C₇, C₈, C₉, C₁₀, C₁₁ or C₁₂) branched alkyl,

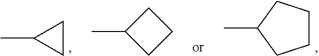

wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
R_{B2} represents —F, —Cl, —CF₃, —OCF₃,

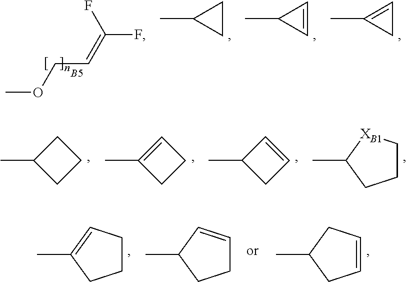

wherein, one or more than two nonadjacent —CH₂— in

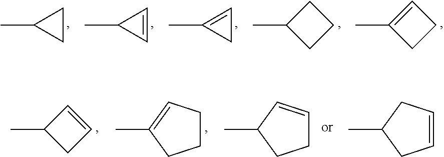

can each be independently replaced by —O—, —S—, —CO—, —CO—O— or —O—CO—, wherein, X_{B1} represents —O— or —S, n_{B5} represents an integer of 0-5;
ring

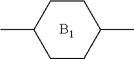

and ring

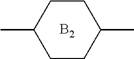

each independently represents

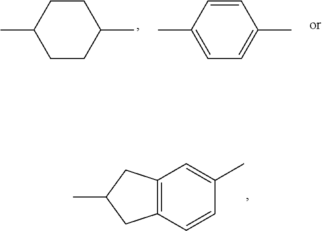

wherein one or more —CH₂— in

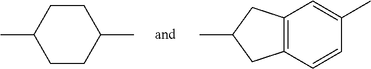

can each be independently replaced by —O— or —S—, and one or at most two single bonds in the rings can replaced by double bond, wherein one or more —H on

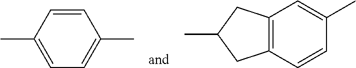

can each be independently substituted by —CN, —F or —Cl, and one or more —CH═ in the rings can be replaced by —N═;
ring

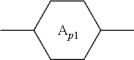

represents

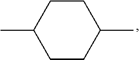

wherein one or more —CH₂— in

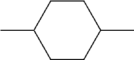

can be replaced by —O—, and one or at most two single bonds in the ring can be replaced by double bond;
X_{B} represents —O—, —S— or —CO—;
Lₚ₁ and Lₚ₂ each independently represents halo;
L_{B1} and L_{B2} each independently represents —H, —F, —Cl, —CF₃ or —OCF₃;
Z_{B1} and Z_{B2} each independently represents —CO—O—, —O—CO—, —OCH₂—, —CH═CH—, —C≡C—, —CH₂CH₂—, —CF₂CF₂—, —(CH₂)n_{B4}-, —(CH₂)n_{B4}O—, —O(CH₂)n_{B4}-, —(CH₂)n_{B4}S—, —S(CH₂)n_{B4}-, —CF₂O— or —OCF₂—, wherein n_{B4} represents an integer of 0-5 (for example, 1, 2, 3 or 4);
n_{B1} and n_{B2} each independently represents 0, 1 or 2, wherein when nB₁ represents 2, ring

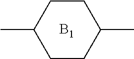

can be the same or different, and wherein when n_{B2} represents 2, ring

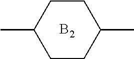

can be the same or different.

In some embodiments of the present invention, the liquid crystal composition further comprises at least one compound of general formula C:

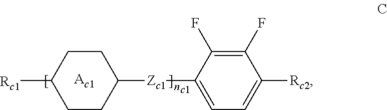

wherein,
R_{c1} and R_{c2} each independently represents C₁₋₂ (for example, C₁, C₂, C₃, C₄, C₅, C₆, C₇, C₈, C₉, C₁₀, C₁₁ or C₁₂) linear alkyl, C₃₋₁₂ (for example, C₃, C₄, C₅, C₆, C₇, C₈, C₉, C₁₀, C₁₁ or C₁₂) branched alkyl,

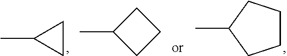

wherein one or more than two nonadjacent —CH₂-in the C₁₋₁₂ linear alkyl or C₃₋₁₂ branched alkyl can each be independently replaced by —CH═CH—, —C≡C—, —O—, —CO—, —CO—O— or —O—CO—;
ring

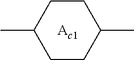

represents

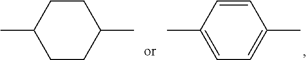

wherein one or more —CH₂— in

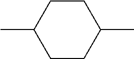

can be replaced by —O—, and one or at most two single bonds in the ring can be replaced by double bond, and wherein one or more —H on

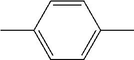

can each be independently substituted by —F, —Cl or —CN, and one or more —CH═ in the ring can be replaced by —N═; wherein at least one ring

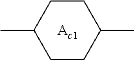

in general formula C represents

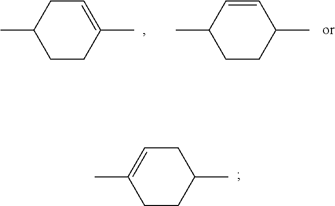

Z_{c1} represents —CO—O—, —O—CO—, —OCH₂—, —CH═CH—, —C≡C—, —CH₂CH₂—, —CF₂CF₂—, —(CH₂)n_{B4}-, —(CH₂)n_{B4}O—, —O(CH₂)n_{B4}-, —(CH₂)n_{B4}S—, —S(CH₂)n_{B4}-, —CF₂O— or —OCF₂—, wherein n_{B4} represents an integer of 0-5; and
n_{c1} represents 1, 2 or 3, when n_{c1}=2 or 3, ring

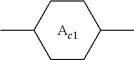

can be the same or different, Z_{c1} can be the same or different.

In some embodiments of the present invention, the compound of general formula P is selected from a group consisting of the following compounds:

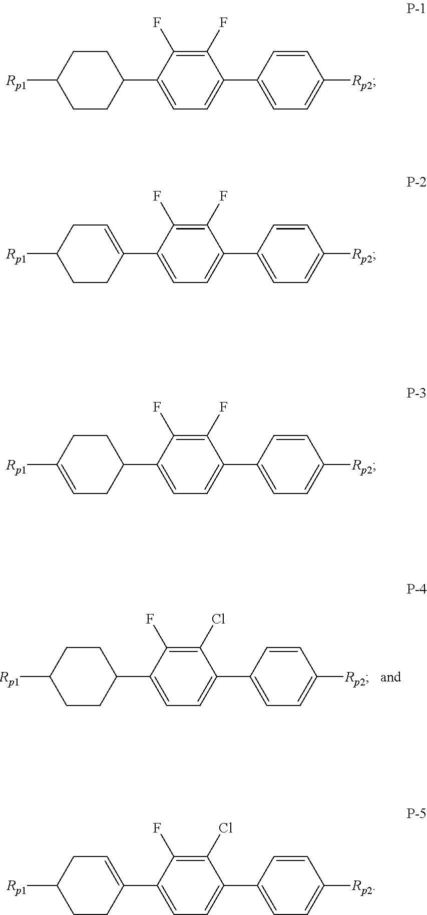

In some embodiments of the present invention, in order to achieve a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, the compound of general formula P comprises at least one (for example, two, three) compound of general formula P-1.

In some embodiments of the present invention, the compound of general formula P comprises at least one compound of general formula P-1 in which Rₚ₁ represents C₂₋₁₂ linear alkenyl.

In some embodiments of the present invention, the compound of general formula P comprises at least one compound of general formula P-1 in which Rₚ₁ represents C₂₋₁₂ linear alkenyl and at least one compound of general formula P-1 in which Rₚ₁ represents C₁₋₁₂ linear alkyl.

In the present invention, it is preferred to adjust the content of the compound of general formula P, such that the liquid crystal composition comprising the same has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

In some embodiments of the present invention, the compound of general formula P provides (in percentage by weight) 0.1%-30% (including any of the numerical values or sub-ranges therebetween) of the liquid crystal composition, for example, 0.1%, 1%, 3%, 4%, 6%, 8%, 10%, 12%, 13%, 14%, 15%, 16%, 18%, 20%, 21.5%, 22%, 24%, 26%, 28%, 30%, or a range between any two numerical values therein.

In some embodiments of the present invention, the compound of general formula B is selected from a group consisting of the following compounds:

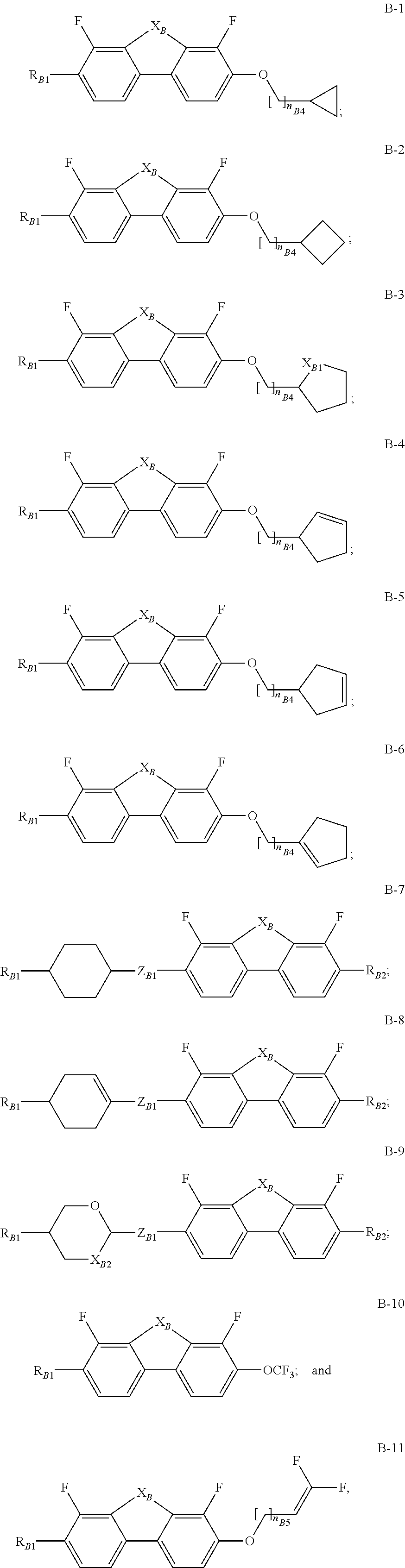

wherein, X_{B2} represents —O—, —S— or —CH₂—.

In some embodiments of the present invention, in order to achieve a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, the compound of general formula B comprises at least one (for example, two, three) compound of general formula B-5 and/or general formula B-11.

In the present invention, it is preferred to adjust the content of the compound of general formula B, such that the liquid crystal composition comprising the same has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

In some embodiments of the present invention, the compound of general formula B provides (in percentage by weight) 0.1%-30% (including any of the numerical values or sub-ranges therebetween) of the liquid crystal composition, for example, 0.1%, 1%, 4%, 6%, 8%, 9%, 10%, 12%, 14%, 16%, 18%, 20%, 22%, 24%, 26%, 28%, 30%, or a range between any two numerical values therein.

In some embodiments of the present invention, the compound of general formula C is selected from a group consisting of the following compounds:

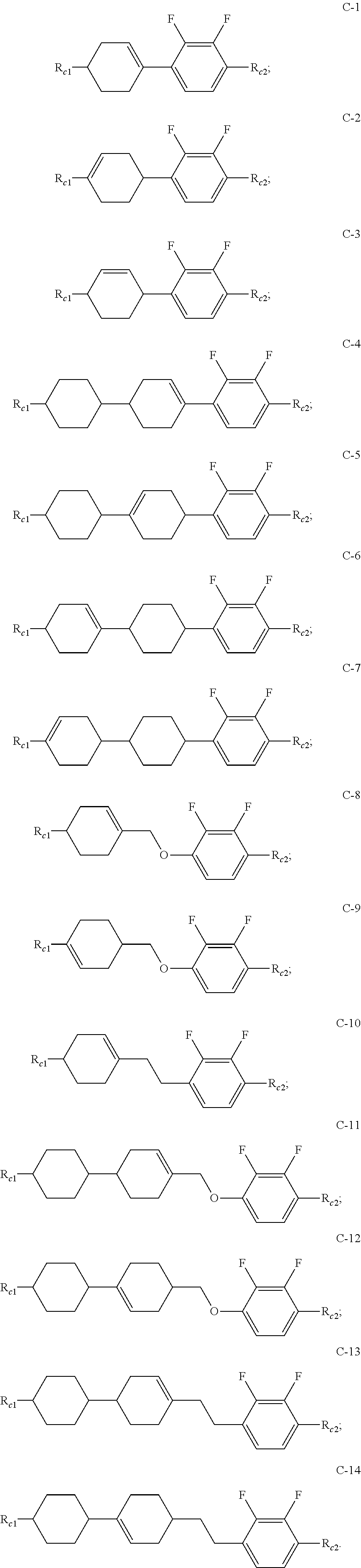

In some embodiments of the present invention, in order to achieve a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, the compound of general formula C is selected from a group consisting of the compound of general formula C-1, the compound of general formula C-4, the compound of general formula C-8 and the compound of general formula C-11.

In some embodiments of the present invention, the compound of general formula C comprises at least one compound selected from a group consisting of the compound of general formula C-1 and the compound of general formula C-4, and at least one compound selected from a group consisting of the compound of general formula C-8 and the compound of general formula C-11.

In the present invention, it is preferred to adjust the content of the compound of general formula C, such that the liquid crystal composition comprising the same has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

In some embodiments of the present invention, the compound of general formula C provides (in percentage by weight) 0.1%-40% (including any of the numerical values or sub-ranges therebetween) of the liquid crystal composition, for example, 0.1%, 1%, 4%, 6%, 7%, 8%, 9%, 9.5%, 10%, 12%, 14%, 16%, 17%, 18%, 20%, 22%, 24%, 26%, 28%, 29%, 30%, 32%, 34%, 36%, 38%, 40%, or a range between any two numerical values therein.

In some embodiments of the present invention, the liquid crystal composition of the present invention further comprises at least one compound of general formula N:

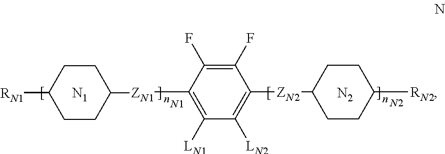

wherein,
R_{N1} and R_{N2} each independently represents C₁₋₁₂ (for example, C₁, C₂, C₃, C₄, C₅, C₆, C₇, C₈, C₉, C₁₀, C₁₁ or C₁₂ linear alkyl, C₃₋₁₂ (for example, C₃, C₄, C₅, C₆, C₇, C₈, C₉, C₁₀, C₁₁ or C₁₂) branched alkyl,

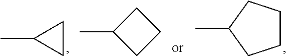

wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring

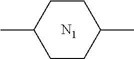

and ring

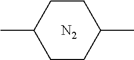

each independently represents

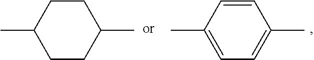

wherein one or more —CH₂— in

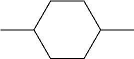

can be replaced by —O—, wherein one or more —H on

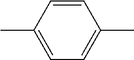

can each be independently substituted by —F, —Cl or —CN, and one or more —CH═ in the ring can be replaced by —N═;
L_{N1} and L_{N2} each independently represents —H, C₁₋₃ (for example, C₁, C₂ or C₃) alkyl or halo;
Z_{N1} and Z_{N2} each independently represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n_{N1} represents 0, 1, 2 or 3, n_{N2} represents 0 or 1, and 0≤n_{N1}+n_{N2}≤3, when n_{N1}=2 or 3, ring

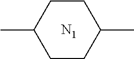

can be the same or different, Z_{N1} can be the same or different; and
when n_{N1} represents 1, and ring

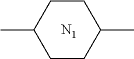

represents

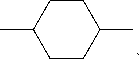

n_{N2}=0.

In some embodiments of the present invention, preferably, R_{N1} and R_{N2} each independently represents C₁₋₁₀ linear alkyl, C₃₋₁₀ branched alkyl, C₁₋₉ linear alkoxy, C₃₋₉ branched alkoxy, C₂₋₁₀ linear alkenyl or C₂₋₁₀ branched alkenyl; further preferably, R_{N1} and R_{N2} each independently represents C₁₋₈ linear alkyl, C₁₋₇ linear alkoxy or C₂₋₈ linear alkenyl.

In some embodiments of the present invention, the compound of general formula N is selected from a group consisting of the following compounds:

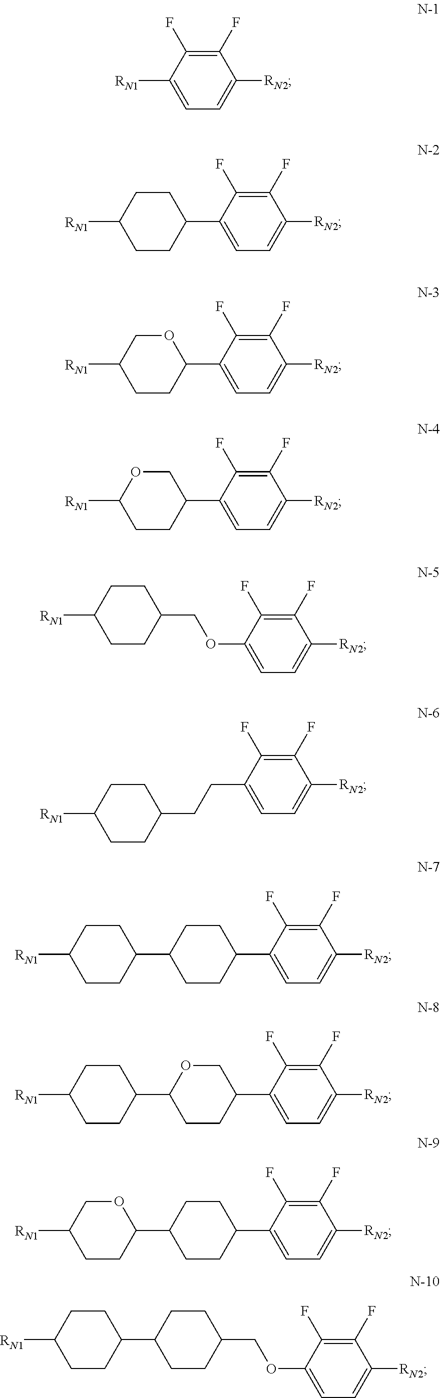

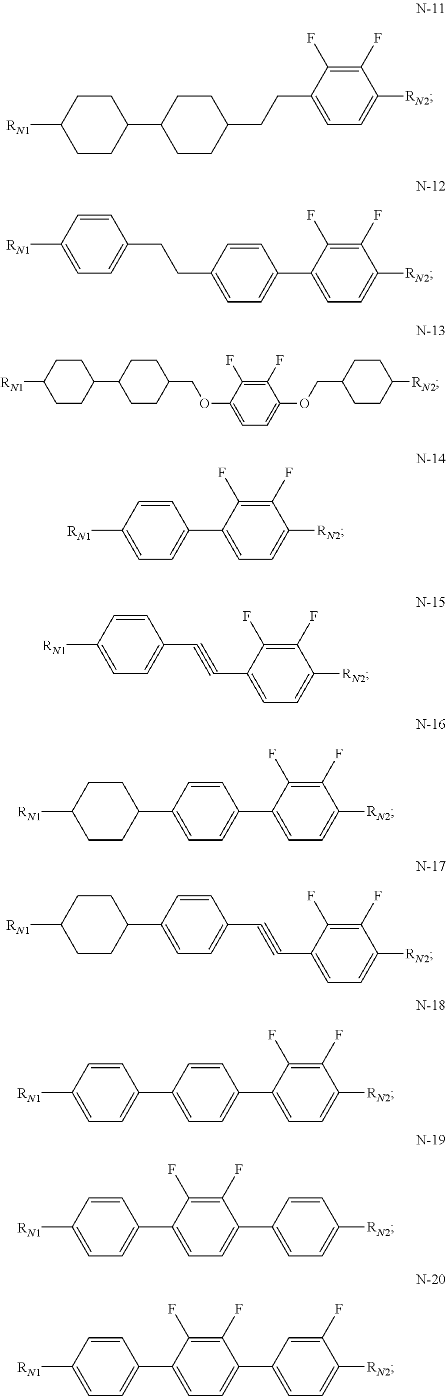

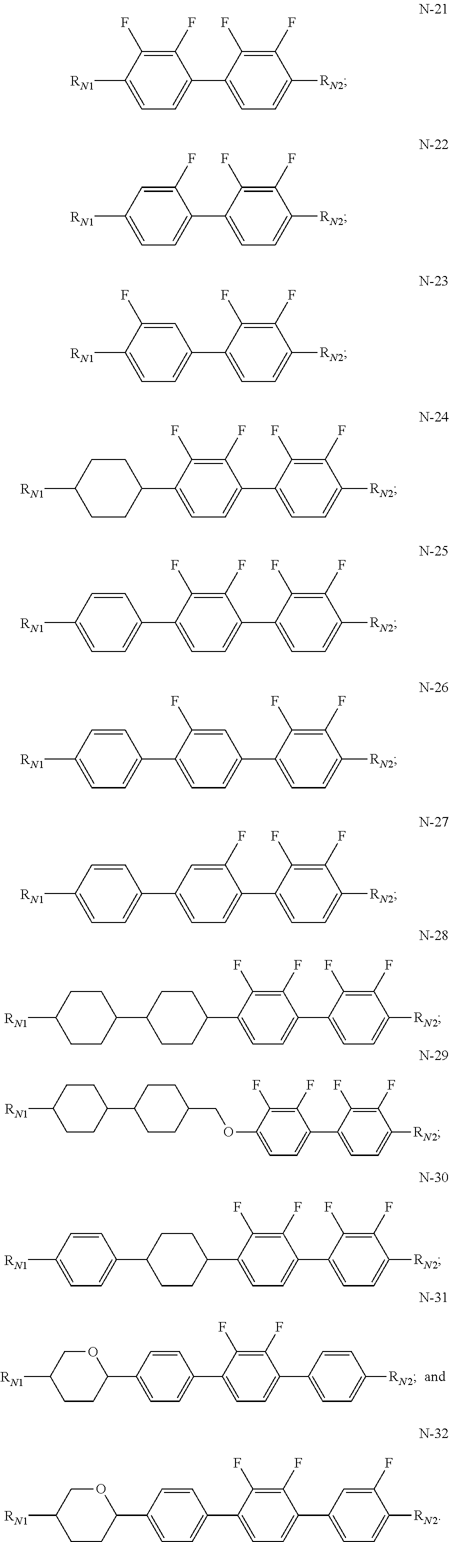

In some embodiments of the present invention, in order to achieve a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, the compound of general formula N is selected from a group consisting of the compound of general formula N-2, the compound of general formula N-7, the compound of general formula N-10, the compound of general formula N-12, the compound of general formula N-14, the compound of general formula N-18, the compound of general formula N-19, the compound of general formula N-22, the compound of general formula N-23, the compound of general formula N-26 and the compound of general formula N-27.

In some embodiments of the present invention, the liquid crystal composition of the present invention comprises at least one compound of general formula N in which R_{N1} represents C₂₋₈ linear alkenyl.

In some embodiments of the present invention, it is preferred to adjust the content of the compound of general formula N, such that the liquid crystal composition comprising the same has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

In some embodiments of the present invention, the compound of general formula N provides (in percentage by weight) 0.1%-40% (including any of the numerical values or sub-ranges therebetween) of the liquid crystal composition, for example, 0.1%, 1%, 4%, 6%, 8%, 10%, 12%, 14%, 16%, 18%, 20%, 22%, 24%, 24.5%, 26%, 28%, 30%, 32%, 32.5%, 34%, 36%, 38%, 40%, or a range between any two numerical values therein.

In some embodiments of the present invention, the liquid crystal composition further comprises at least one compound of general formula M:

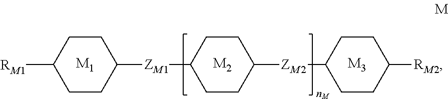

wherein,
R_{M1} and R_{M2} each independently represents C₁₋₁₂ (for example, C₁, C₂, C₃, C₄, C₅, C₆, C₇, C₈, C₉, C₁₀, C₁₁ or C₁₂) linear alkyl, C₃₋₁₂ (for example, C₃, C₄, C₅, C₆, C₇, C₈, C₉, C₁₀, C₁₁ or C₁₂) branched alkyl,

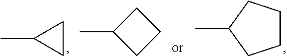

wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring

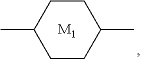

ring

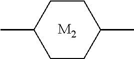

and ring

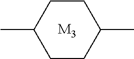

each independently represents

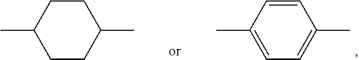

wherein one or more —CH₂— on

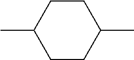

can be replaced by —O—, one or at most two single bonds in the ring can be replaced by double bond, at most one —H on

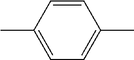

can be substituted by halo;
Z_{M1} and Z_{M2} each independently represents single bond, —CO—O—, —O—CO—, —CH₂O—, —OCH₂—, —C≡C—, —CH═CH—, —CH₂CH₂- or —(CH₂)₄—; and
n_{M} represents 0, 1 or 2, wherein when n_{M}=2, ring

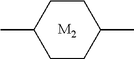

can be the same or different, Z_{M2} can be the same or different.

In some embodiments of the present invention, preferably, R_{M1} and R_{M2} each independently represents C₁₋₁₀ linear alkyl, C₃₋₁₀ branched alkyl, C₁₋₉ linear alkoxy, C₃₋₉ branched alkoxy, C₂₋₁₀ linear alkenyl or C₄₋₁₀ branched alkenyl; further preferably, R_{M1} and R_{M2} each independently represents C₁₋₈ linear alkyl, C₁₋₇ linear alkoxy or C₂₋₈ linear alkenyl.

In some embodiments of the present invention, preferably, R_{M1} and R_{M2} each independently represents C₂₋₈ linear alkenyl; further preferably, R_{M1} and R_{M2} each independently represents C₂₋₅ linear alkenyl.

In some embodiments of the present invention, preferably, one of R_{M1} and R_{M2} is C₂₋₅ linear alkenyl, while the other is C₁₋₅ linear alkyl.

In some embodiments of the present invention, preferably, R_{M1} and R_{M2} each independently represents C₁₋₈ linear alkoxy; further preferably, R_{M1} and R_{M2} each independently represents C₁₋₅ linear alkoxy.

In some embodiments of the present invention, preferably, one of R_{M1} and R_{M2} is C₁₋₅ linear alkoxy, while the other is C₁₋₅ linear alkyl.

In some embodiments of the present invention, with emphasis in reliability, both R_{M1} and R_{M2} are preferably alkyl; with emphasis in reducing the volatility of the compound, both R_{M1} and R_{M2} are preferably alkoxy; and with emphasis in reducing the viscosity, at least one of R_{M1} and R_{M2} is preferably alkenyl.

In some embodiments of the present invention, the compound of general formula M is selected from a group consisting of the following compounds:

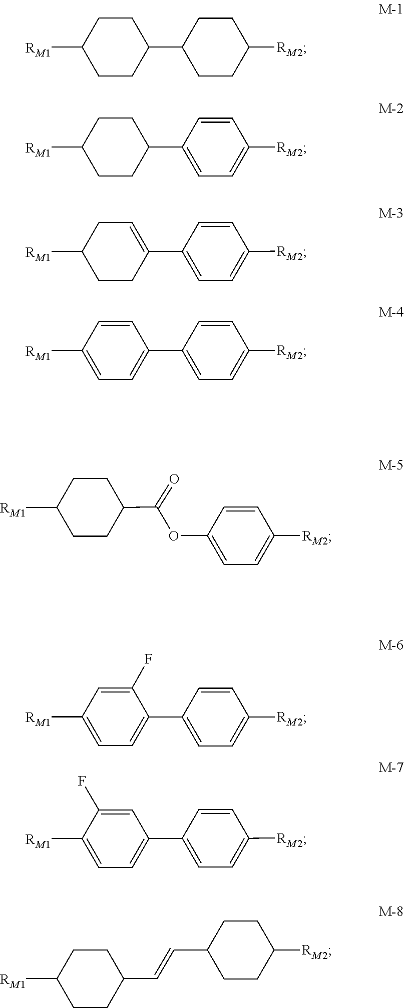

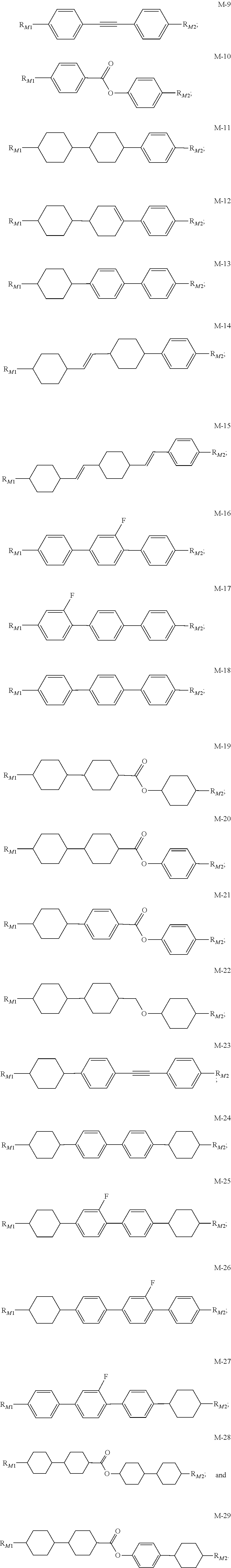

In some embodiments of the present invention, in order to achieve a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, the compound of general formula M is selected from a group consisting of the compound of general formula M-1, the compound of general formula M-2, the compound of general formula M-4, the compound of general formula M-11, the compound of general formula M-13, the compound of general formula M-14, the compound of general formula M-16, the compound of general formula M-19, the compound of general formula M-22 and the compound of general formula M-25.

In some embodiments of the present invention, the compound of general formula M comprises at least one (for example, two, three) compound of general formula M-1 in which R_{M2} represents C₂₋₅ linear alkenyl, preferably, the compound of general formula M comprises at least two compounds of general formula M-1 in which R_{M2} represents C₂₋₅ linear alkenyl.

In some embodiments of the present invention, it is preferred to adjust the content of the compound of general formula M, such that the liquid crystal composition comprising the same has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

In some embodiments of the present invention, the compound of general formula M provides (in percentage by weight) 0.1%-70% (including any of the numerical values or sub-ranges therebetween) of the liquid crystal composition, for example, 0.1%, 1%, 4%, 6%, 8%, 10%, 12%, 14%, 16%, 18%, 20%, 22%, 24%, 26%, 28%, 30%, 32%, 34%, 36%, 38%, 39.5%, 40%, 41%, 42%, 42.5%, 43.5%, 44%, 45%, 46%, 47%, 48%, 50%, 51.5%, 52%, 54%, 56%, 58%, 60%, 62%, 64%, 66%, 68%, 70%, or a range between any two numerical values therein.

In some embodiments of the present invention, in order to achieve a smaller roughness, a better pre-tilt angle stability, a lower residue concentration and a higher VHR stability, the liquid crystal composition further comprises at least one polymerizable compound of general formula RM:

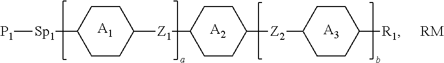

wherein,
R₁ represents —H, halo, —CN, -Sp₂-P₂, C₁₋₁₂ (for example, C₁, C₂, C₃, C₄, C₅, C₆, C₇, C₈, C₉, C₁₀, C₁₁ or C₁₂) linear alkyl, C₃₋₁₂ (for example, C₃, C₄, C₅, C₆, C₇, C₈, C₉, C₁₀, C₁₁ or C₁₂) branched alkyl,

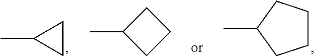

wherein one or more than two nonadjacent —CH₂— in the C₁₋₁₂ linear alkyl, C₃₋₁₂ branched alkyl,

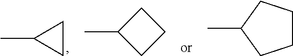

or can each be independently replaced by —CH═CH—, —C≡C—, —O—, —CO—, —CO—O— or —O—CO—, and one or more —H can each be independently substituted by —F or —Cl;
ring

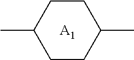

and ring

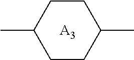

each independently represents

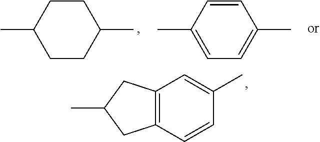

wherein one or more —CH₂— in

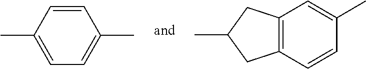

can be replaced by —O—, and one or at most two single bonds in the ring can be replaced by double bond, wherein one or more —H on

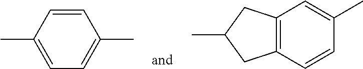

can each be independently substituted by —F, —Cl, —CN, -Sp₃-P₃, C₁₋₁₂ (for example, C₁, C₂, C₃, C₄, C₅, C₆, C₇, C₈, C₉, C₁₀, C₁₁ or C₁₂) halogenated or unhalogenated linear alkyl, C₁₋₁₁ (for example, C₁, C₂, C₃, C₄, C₅, C₆, C₇, C₈, C₉, C₁₀, C₁₁ or C₁₂) halogenated or unhalogenated linear alkoxy,

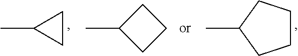

and one or more —CH═ in the rings can be replaced by —N═;
ring

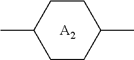

represents

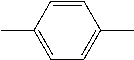

wherein one or more —H on

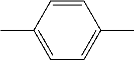

can each be independently substituted by —F, —Cl, —CN, -Sp₃-P₃, C₁₋₆ (for example, C₁, C₂, C₃, C₄, C₅ or C₆) halogenated or unhalogenated linear alkyl, C₁₋₅ (for example, C₁, C₂, C₃, C₄ or C₅) halogenated or unhalogenated linear alkoxy,

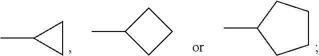

and one or more —CH═ in the ring can be replaced by —N═;
P₁, P₂ and P₃ each independently represents polymerizable group;
Sp₁, Sp₂ and Sp₃ each independently represents spacer group or single bond;
Z₁ and Z₂ each independently represents —O—, —S—, —CO—. —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF=CF—, —CH═CF—, —CF=CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ (for example, C₂, C₃, C₄, C₅, C₆, C₇, C₈, C₉, C₁₀ or C₁₁) linear alkyl, and d represents an integer of 1-4 (for example, 1, 2, 3 or 4); and
a represents 0, 1 or 2, b represents 0 or 1, wherein when a represents 2, ring

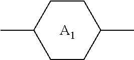

can be the same or different. Z₁ can be the same or different.

In some embodiments of the present invention, the polymerizable compound of general formula RM is selected from a group consisting of the following compounds:

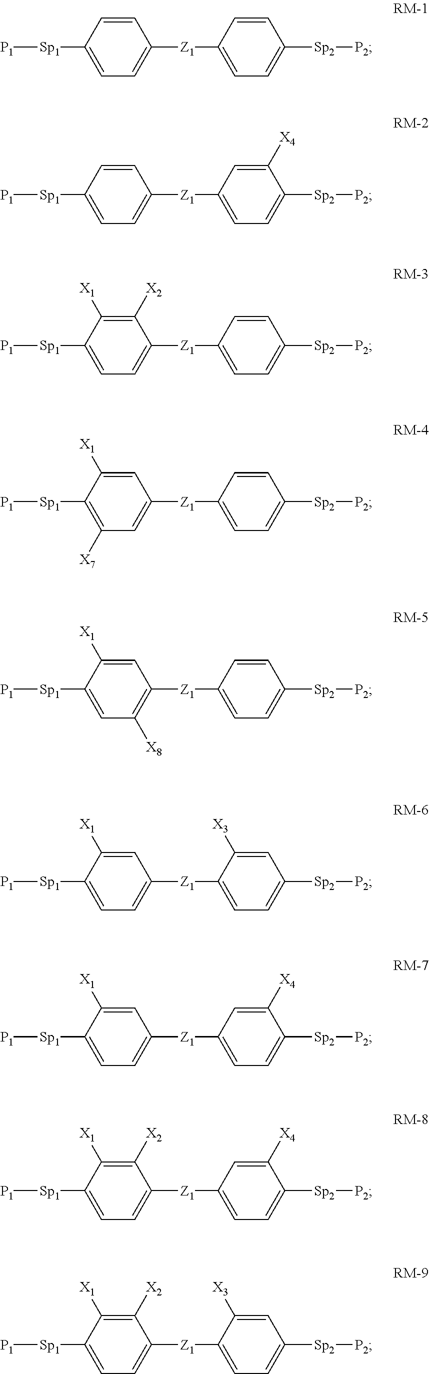

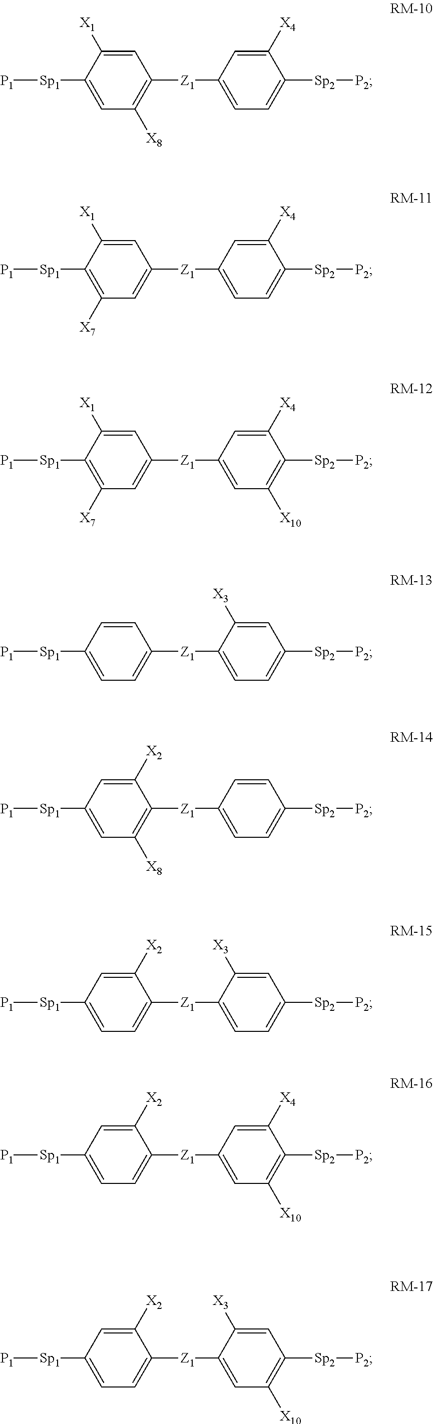

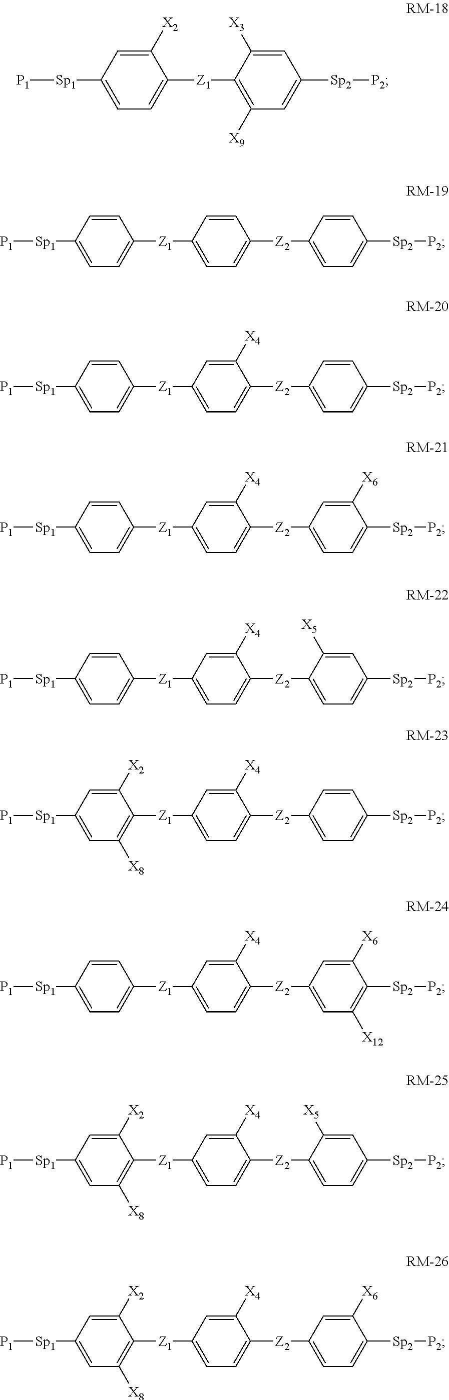

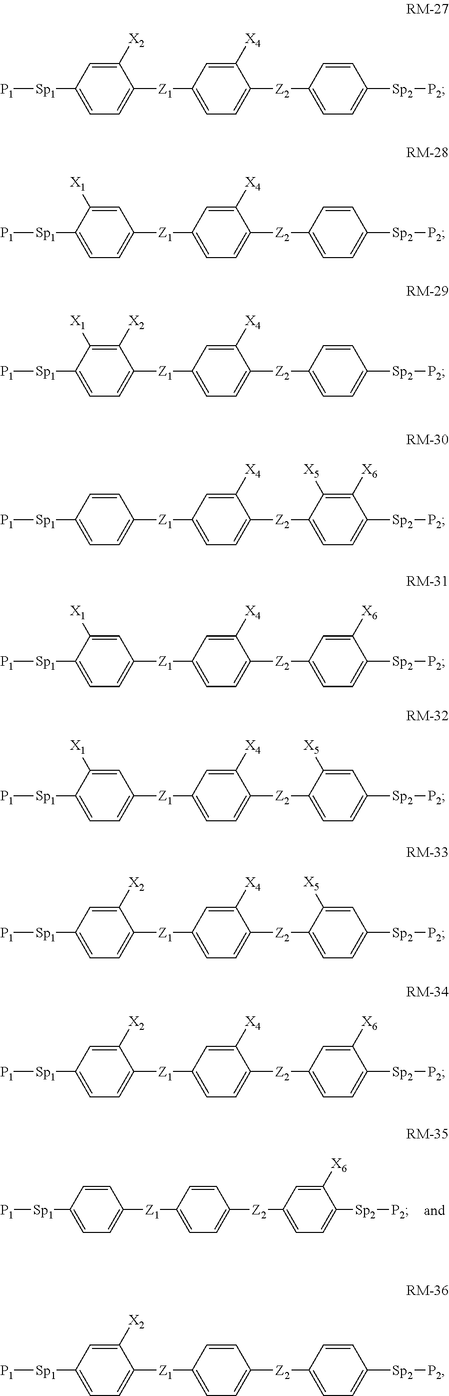

wherein,
X₁—X₁₀ and X₁₂ each independently represents —F, —Cl, -Sp₃-P₃, C₁₋₅ linear alkyl or alkoxy,

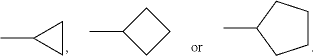

In some embodiments of the present invention, X₁—X₁₀ and X₁₂ each independently represents —F, —Cl, -Sp₃-P₃, —CH₃, —OCH₃, —C₂H₅ or —OC₂H₅.

In some embodiments of the present invention, both Sp₁ and Sp₂ represent single bond.

In some embodiments of the present invention, in order to achieve a smaller roughness, a better pre-tilt angle stability, a lower residue concentration and a higher VHR stability, the polymerizable compound of general formula RM is selected from a group consisting of the compound of general formula RM-1 and the compound of general formula RM-2.

The polymerizable groups involved in the present invention are groups suitable for polymerization reactions (for example, radical or ionic bond polymerization, addition polymerization or condensation polymerization), or groups suitable for addition or condensation on the polymer backbone. For chain polymerization, a polymerizable group containing —CH═CH— or —C≡C— is particularly preferred, and for ring-opening polymerization, for example, an oxetane or epoxy group is particularly preferred.

In some embodiments of the present invention, the polymerizable groups P₁, P₂ and P₃ each independently represents

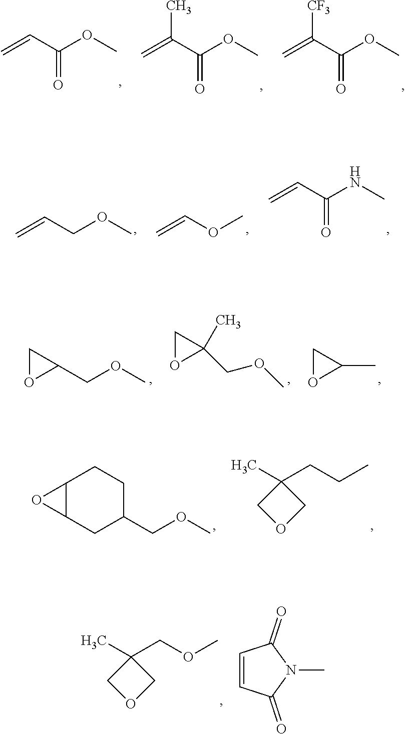

or —SH; preferably, the polymerizable groups P₁, P₂ and P₃ each independently represents

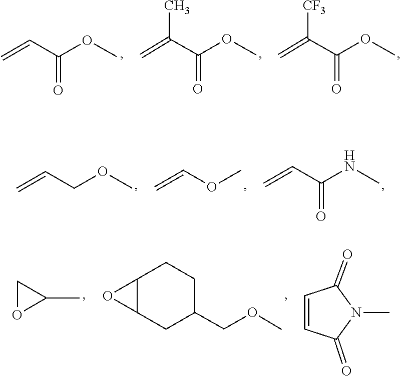

or —SH; further preferably, the polymerizable groups P₁, P₂ and P₃ each independently represents

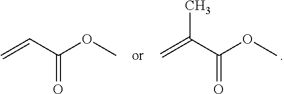

In some embodiments of the present invention, the polymerizable compound of general formula RM-1 is selected from a group consisting of the following compounds:

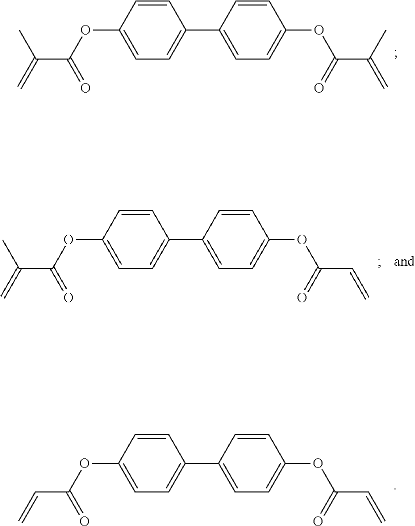

In some embodiments of the present invention, the polymerizable compound of general formula RM-13 is selected from a group consisting of the following compounds:

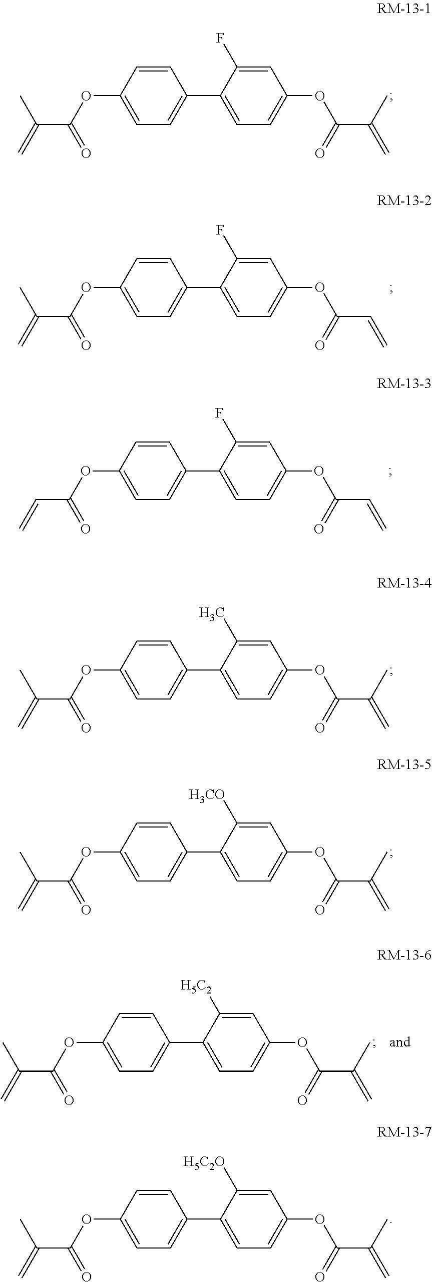

The term “spacer group” as used herein, is known to the person skilled in the art and is described in the literature, for example, Pure Appl. Chem. 2001, 73(5), 888 and C. Tschierske, G. Pelzl, S. Diele, Angew. Chem. 2004, 116, 6340-6368. As used herein, the term “spacer group” refers to a flexible group which connects the mesogenic group and the polymerizable group(s) in a polymerizable compound. Representative spacer group for example is —(CH₂)p₁-, —(CH₂)ₚ₁—O—, —O—(CH₂)ₚ₁—, —(CH₂)ₚ₁—O—CO—, —(CH₂)ₚ₁—CO—O—, —(CH₂)ₚ₁—O—CO—O—, —(CH₂CH₂O)q₁-CH₂CH₂—, —(CH₂CH₂S)q₁-CH₂CH₂—, —(CH₂CH₂NH)q₁-CH₂CH₂—, —CR⁰R⁰⁰—(CH₂)ₚ₁— or —(SiR⁰R⁰⁰—O)p₁-, wherein, p₁ represents an integer of 1-12 (for example, 1, 2, 3, 4, 5, 6, 7, 8, 9, 10, 11 or 12), q₁ represents an integer of 1-3 (for example, 1, 2 or 3), R⁰ and R⁰⁰ each independently represents —H, C₁₋₁₂ (for example, C₁, C₂, C₃, C₄, C₅, C₆, C₇, C₈, C₉, C₁₀, C₁₁ or C₁₂) linear or branched alkyl, or C₃₋₁₂ (for example, C₃, C₄, C₅, C₆, C₇, C₈, C₉, C₁₀, C₁₁ or C₁₂) cycloalkyl. The particularly preferred spacer group is —(CH₂)p₁-, —(CH₂)p₁-O—, —(CH₂)p₁-O—CO—, —(CH₂)p₁-CO—O—, —(CH₂)p₁-O—CO—O— or —CR⁰R⁰⁰—(CH₂)ₚ₁—.

In some embodiments of the present invention, it is preferred to adjust the content of the compound of general formula RM, such that the liquid crystal composition of the present application has a smaller roughness, a better pre-tilt angle stability, a lower residue concentration and a higher VHR stability.

In some embodiments of the present invention, the polymerizable compound of general formula RM provides (in percentage by weight) 0.001%-5% (including any of the numerical values or sub-ranges therebetween) of the liquid crystal composition, for example, 0.001%, 0.002%, 0.004%, 0.005%, 0.006%, 0.008%, 0.01%, 0.02%, 0.04%, 0.06%, 0.08%, 0.1%, 0.2%, 0.25%, 0.26%, 0.27%, 0.28%, 0.29%, 0.3%, 0.32%, 0.33%, 0.34%, 0.35%, 0.4%, 0.5%, 0.6%, 0.8%, 1%, 1.2%, 1.6%, 1.8%, 2%, 2.5%, 3%, 3.5%, 4%, 4.5%, 5%, or a range between any two numerical values therein.

As used herein, both —CO— and —C(O)— represent carbonyl group.

As used herein, the term “C₁₋ᵣ” (wherein r is an integer greater than 1) may refer to any integer number (between 1 and r, including the end values 1 and r) of carbon atom(s), e.g., C₂, C₍ᵣ₋₁₎ or Cr. For example, “C1-12” may include C₁, C₂, C₃, C₄, C₅, C₆, C₇, C₈, C₉, C₁₀, C₁₁ or C₁₂.

As used herein, the term “an integer of y₁-y₂” may refer to any integer within this rang (including the end values y₁ and y₂). For example, “an integer of 0-12” may be, such as, 0, 1, 2, 3, 4, 5, 6, 7, 8, 9, 10, 11 or 12.

In some embodiments of the present invention, the liquid crystal composition further comprises at least one additive.

In addition to the above compounds, the liquid crystal composition of the present invention may also contain conventional nematic liquid crystal compound, smectic liquid crystal compound, cholesteric liquid crystal compound, dopants, antioxidant, ultraviolet absorber, infrared absorber, polymerizable monomer or light stabilizer and so forth.

Dopants which may be preferably added to the liquid crystal composition according to the present invention are shown below:

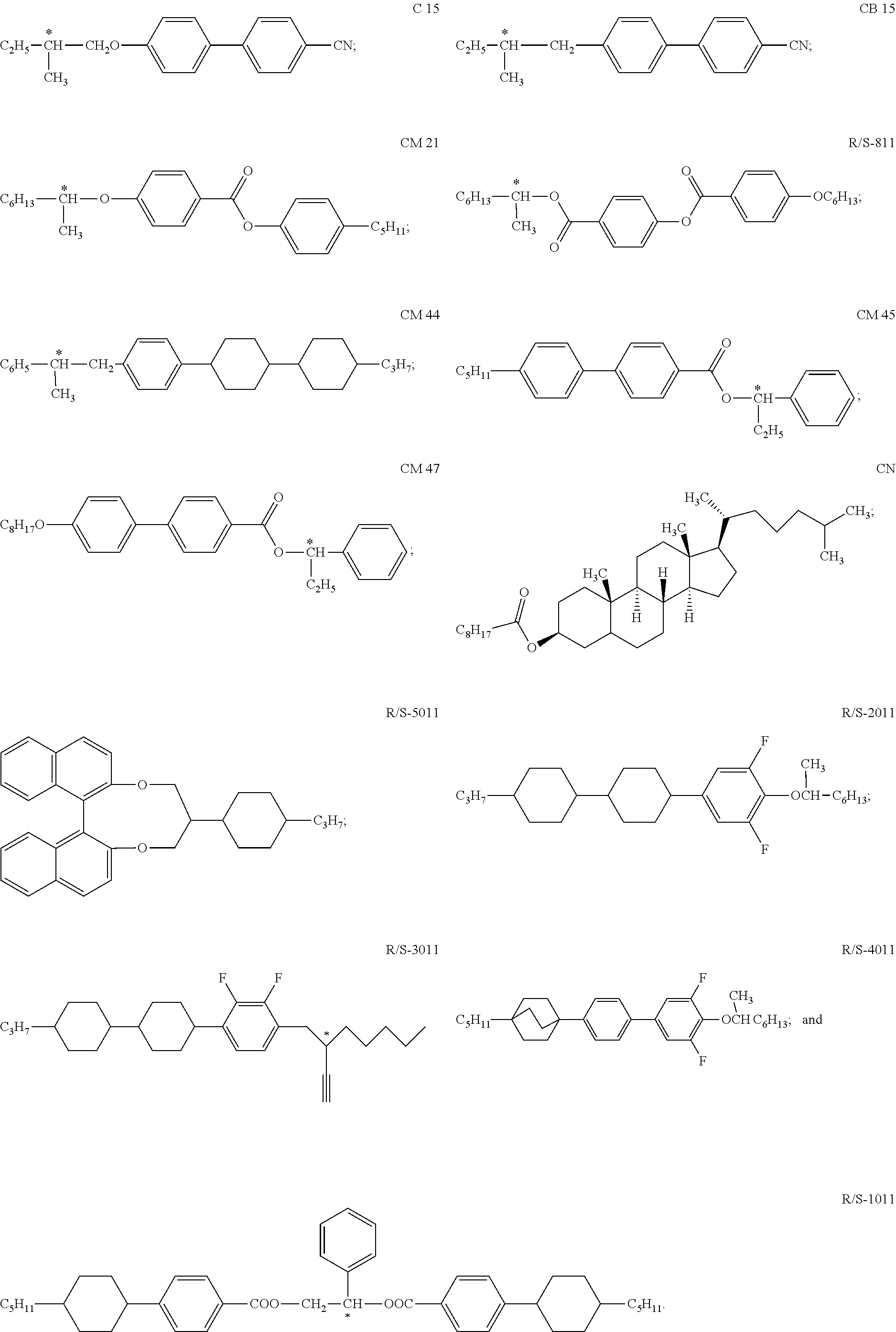

In some embodiments of the present invention, the dopant provides (in percentage by weight) 0%-5% of the liquid crystal composition; preferably, the dopant provides (in percentage by weight) 0.01%-1% of the liquid crystal composition.

Further, additives (such as antioxidant, light stabilizer, ultraviolet absorber and the forth) used in the liquid crystal composition of the present invention are preferably selected from the following substances:

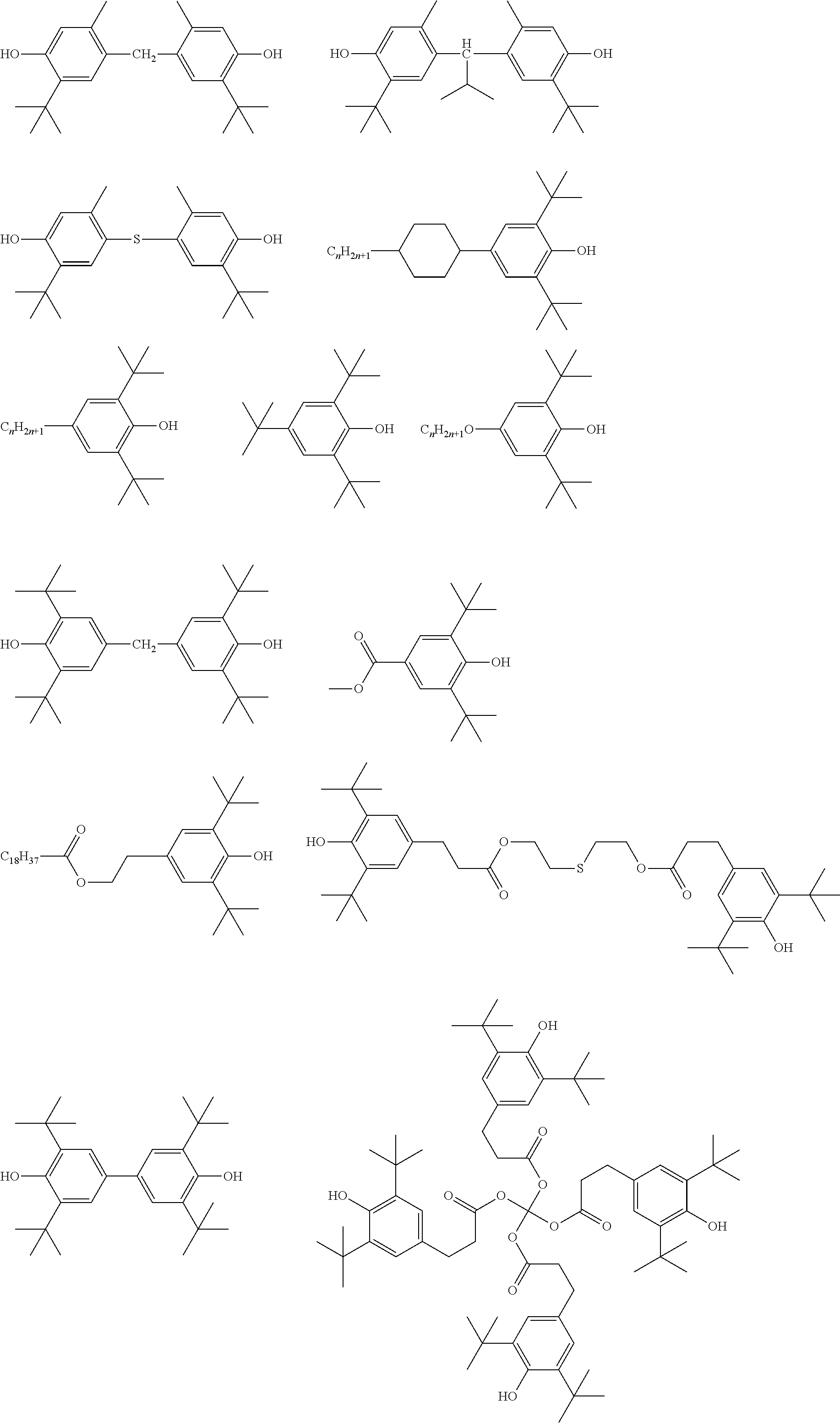

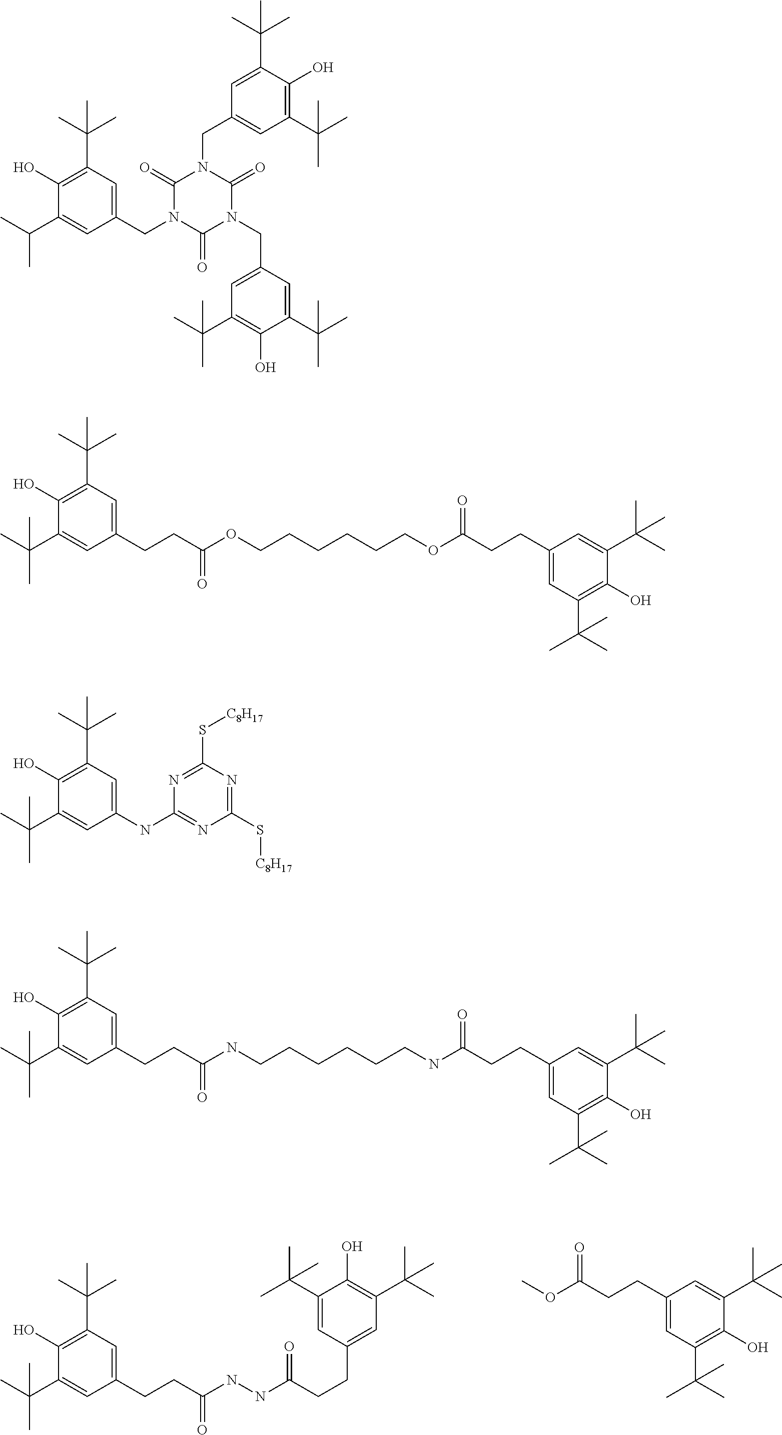

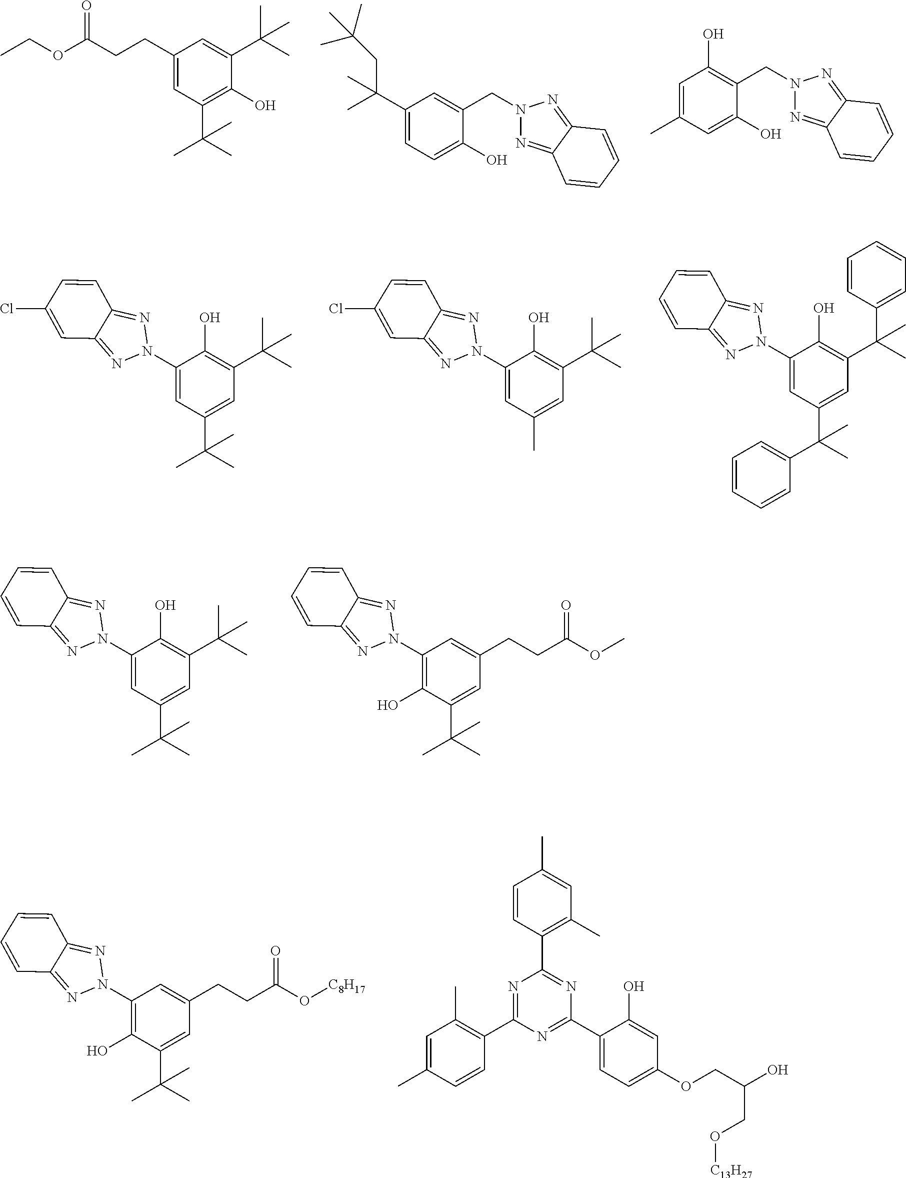

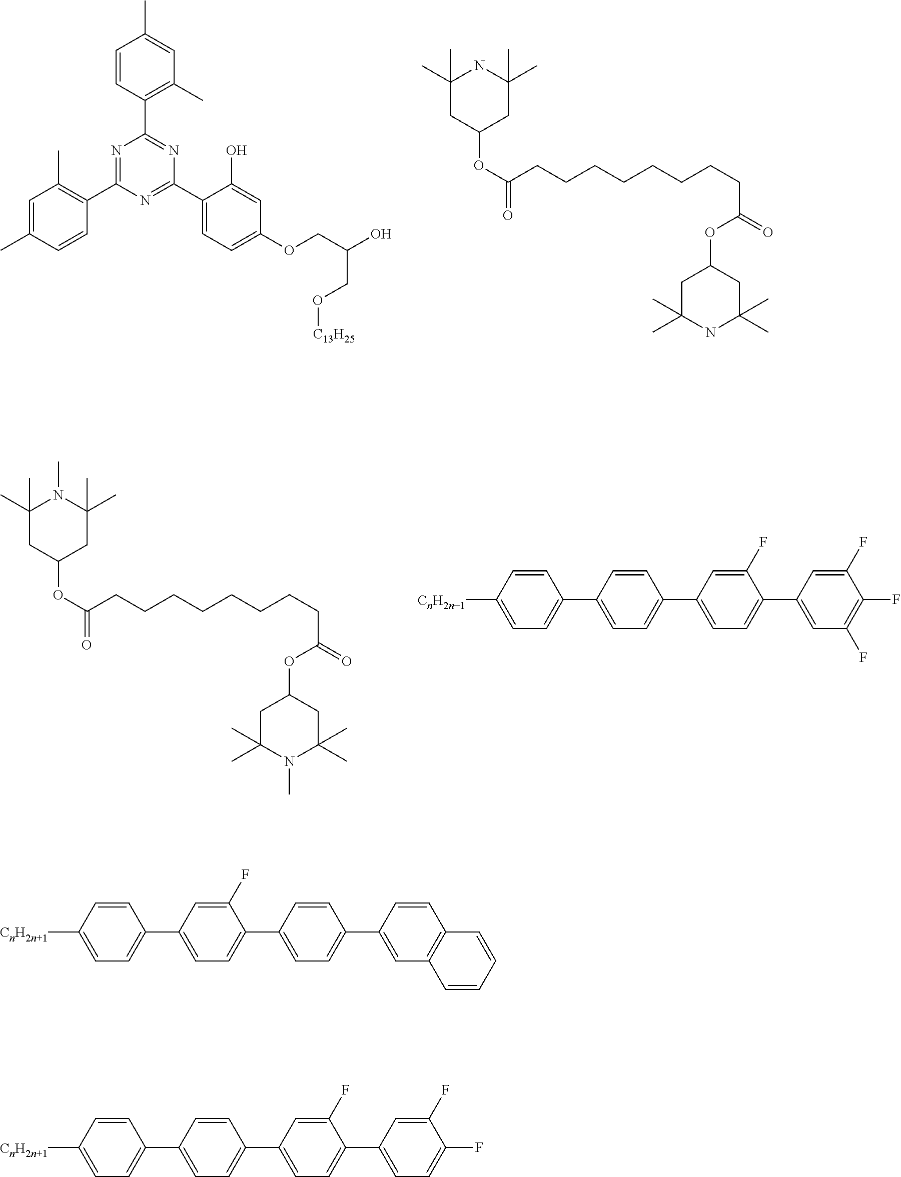

wherein, n represents a positive integer of 1-12.

Preferably, the antioxidant is selected from the compounds as shown below:

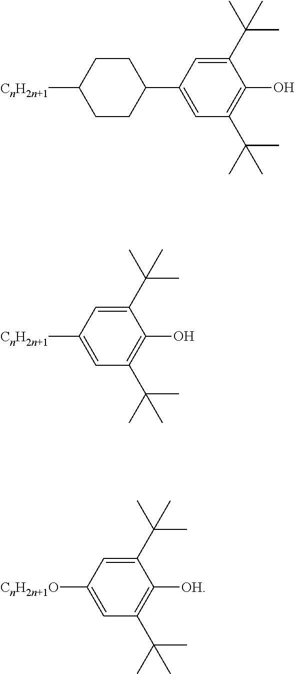

wherein, n represents a positive integer of 1-12.

In some embodiments of the present invention, the additive provides (in percentage by weight) 0%-5% of the liquid crystal composition, preferably, the additive provides (in percentage by weight) 0.01%-1% of the liquid crystal composition.

The liquid crystal composition containing polymerizable compound of the present invention can be polymerized even in the absence of a polymerization initiator. However, polymerization initiator(s) may also be contained therein to promote polymerization. Regarding the polymerization initiators, the following can be listed: benzoin ethers, benzophenones, acetophenones, benzyl ketals, acylphosphine oxides, and the like.

In another aspect, the present invention further provides a liquid crystal display device, the liquid crystal display device comprises the liquid crystal composition described above.

In some embodiments of the present invention, the liquid crystal composition of the present invention is particularly suitable for VA, OCB, IPS, FFS and TN type liquid crystal type display devices.

Beneficial effects: As compared with the prior art, the liquid crystal composition of the present invention has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value, such that the liquid crystal display device comprising the same has a better contrast, a wider temperature range for application, a better transmittance as well as less flicker and a better screen display effect, and when applied to PSA type liquid crystal display mode, the liquid crystal composition has a smaller roughness, a better pre-tilt angle stability, a lower residue concentration and a higher VHR stability.

### DETAILED EMBODIMENTS

The present invention will be illustrated by combining the detailed embodiments below. It should be noted that, the following examples are exemplary embodiments of the present invention, which are only used to illustrate the present invention, not to limit it. Other combinations and various modifications within the conception of the present invention are possible without departing from the subject matter or scope of the present invention.

In the present application, unless otherwise specified, the proportions used herein are weight ratios, and temperatures are Celsius temperatures.

For the convenience of the expression, the group structures of each compound in the following Examples are represented by the codes listed in Table 1:

TABLE 1
Codes of the group structures of the compounds

| Unit structure of group | Code | Name of group |
|---|---|---|
| 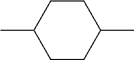 | C | 1,4-cyclohexylidene |
| 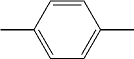 | P | 1,4-phenylene |
| 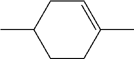 | L | 1,4-cyclohexenylene |
| 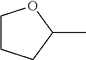 | THF | tetrahydrofuran-2-yl |
| 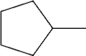 | C(5) | cyclopentyl |
| 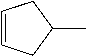 | C(5,V) | 3-cyclopentenyl |
| 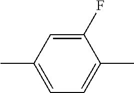 | G | 2-fluoro-1,4-phenylene |
| 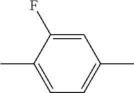 | G′ | 3-fluoro-1,4-phenylene |
| 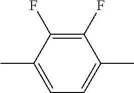 | W | 2,3-difluoro-1,4-phenylene |
| 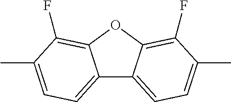 | B(O) | 4,6-difluoro-dibenzo[b,d]furan-3,7-diyl |
| 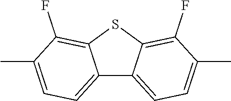 | B(S) | 4,6-difluoro-dibenzo[b,d]thiophene-3,7- diyl |
| —F | F | fluorine substituent |
| 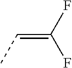 | V(2F) | difluorovinyl |
| —CH═CH— or —CH═CH₂ | V | vinylidene or vinyl |
| —O— | O | oxygen bridge group |
| —CH₂O— | 10 | methyleneoxy |
| —COO— | E | ester bridge bond |
| —CH₂CH₂— | 2 | ethyl bridge bond |
| —CₙH₂ₙ₊₁ or —CₙH₂ₙ— | n (n represents a | alkyl or alkylene |
| | positive integer | |
| | of 1-12) | |

Take the compound with the following structural formula as an example:

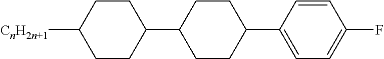

Represented by the codes listed in Table 1, this structural formula can be expressed as nCCPF, in which, n in the code represents the number of the carbon atoms of the alkyl on the left, for example, n is “3”, meaning that the alkyl is —C₃H₇; C in the code represents 1,4-cyclohexylidene, P represents 1,4-phenylene, and F represents fluoro substituent.

The abbreviated codes of the test items in the following Examples are as follows:
Cp clearing point (nematic-isotropy phases transition temperature, ° C.)
Δn optical anisotropy (light wavelength 589 nm, 20° (C)
Δε dielectric anisotropy (1 KHz, 20° C.)
ε_{⊥} dielectric constant perpendicular to the molecular axis (1 KHz, 20° C.)
Flicker flickering value (dB, 20° C.)
Kₐᵥₑ average elastic constant (20° C.)
K₁₁ splay elastic constant (20° C.)
K₃₃ bend elastic constant (20° C.)
γ₁ rotational viscosity (mPa·s, 20° C.)
RT response time (ms, 20° C.)
Tr transmittance (%, 20° C.)
CR contrast
t_{-40° C.} low-temperature storage time (h)
Ra surface roughness (nm)
PTA pre-tilt angle (°, 20° C.)
ΔPTA stability of pre-tilt angle (change in pre-tilt angle after applying a voltage for a fixed time, °)
VHR voltage holding ratio after applying UV2 for 70 min (%)
wherein,
Cp: measured with melting point apparatus.
Δn: tested using an Abbe Refractometer under a sodium lamp (589 nm) light source at 20° C.

Δε: Δε=ε_{∥}−ε_{⊥}, wherein, ε_{∥} is the dielectric constant parallel to the molecular axis, ε_{⊥} is the dielectric constant perpendicular to the molecular axis; test conditions: 20° C., 1 KHz, VA-type test cell with a cell gap of 6 μm.

γ₁: measured using a LCM-2 type liquid crystal physical property evaluation system; test conditions: 20° C., 160 V-260 V, test cell gap 20 μm.

K₁₁ and K₃₃: calculated from the measured C—V curve of the liquid crystal using LCR meter and a VA type test cell, test conditions: cell gap 6 μm, V=0.1~20 V, 20° C.

Kₐᵥₑ: Kₐᵥₑ=(K₁₁+K₂₂+K₃₃)/3, wherein K₁₁, K₂₂ and K₃₃ are calculated from the measured C—V curve of the liquid crystal using LCR meter and a VA type test cell; test conditions: cell gap 6 μm, V=0.1~20 V, 20° C.

Tr: the V-T profile of the optic-tunable device is measured using a DMS 505 optical-electro comprehensive performance tester, and the maximum value of the transmittance in the V-T profile is taken as the transmittance of the liquid crystal, in which the test cell is a negative IPS mode cell with a cell gap of 3.5 μm.

RT: measured using a DMS 505 photoelectric comprehensive tester, test conditions: 20° C. V100 driving, the test cell is a negative IPS mode cell with a cell gap of 3.5 μm.

Flicker: measured using a DMS 505 tester, test conditions: 20° C. 40 HZ, L127 voltage driving, a negative FFS mode test cell with a cell gap of 3.5 μm.

CR: testing the transmittance (i.e., Tᵣ₂₅₅ and Tᵣ₀) of the liquid crystal cell using a DMS 505 tester at 255 gray-scale voltage and 0 gray-scale voltage respectively, and obtained from Tᵣ₂₅₅/Tᵣ₀.

t_{-40° C.}: placing the nematic liquid crystal media in a 7 μm antiparallel cell, storing at −40° C., and recording the time when crystal precipitation is observed.

Ra: after UV2 photopolymerization of the polymerizable compound contained in the liquid crystal composition for 70 min, the liquid crystal molecules are rinsed and then the surface roughness of the polymerized polymer layer is tested with an atomic force microscope (AFM).

PTA: measured by crystal rotation method. Liquid crystals are filled into VA type test cell (cell gap 3.5 μm), and irradiated with ultraviolet light as described in UV1 step with the application of a voltage (15 V, 60 Hz), causing polymerization of the polymerizable compound and generation of pre-tilt angle PTA1, the liquid crystal composition with the generated pre-tilt angle PTA1 is subsequently irradiated with ultraviolet light as described in UV2 step to remove residual polymerizable compounds in the PTA1 state, and at this time the pre-tilt angle formed by the polymerizable compound is PTA2. In the present invention, the polymerization rate of polymerizable compound is investigated through the comparation of the pre-tilt angles formed after the same exposure time of UV1 irradiation (the smaller the pre-tilt angle, the faster the polymerization rate) or the times for forming the same pre-tilt angle (the shorter the time required for forming the same pre-tilt angle, the fast the polymerization rate).

ΔPTA: after the test cell used in the measurement of PTA is subjected to UV1 and UV2 steps to form a pre-tilt angle of 88±0.2°, 60 Hz SW wave, AC voltage (20 V) and DC voltage (2 V) are applied to the test cell at 40° C. with the presence of backlight. After a fixed time period (168 h), the pre-tilt angle of the test cell is tested, and ΔPTA_{(168 h)}=PTA₍ᵢₙᵢₜᵢₐₗ₎−PTA_{(168 h)}, the smaller the ΔPTA_{(168 h)}, the better the stability of the pre-tilt angle.

residue concentration: after applying UV2 irradiation for 70 minutes, the liquid crystal eluted from the liquid crystal test cell is detected by high-performance liquid chromatography (HPLC), and the concentration of polymerizable compounds therein is called residue concentration (ppm).

VHR: measured using a TOY06254 type liquid crystal physical property evaluation system after the application of UV2 (0.25 mw/cm⁻², 313 nm) for 70 minutes; test conditions: 60° C., 1 V, 0.6 Hz, VA type test cell with a cell gap of 9 μm.

The components used in the following Examples can either be synthesized by method known in the art or be obtained commercially. These synthetic techniques are conventional, and each of the obtained liquid crystal compounds is tested to meet the standards of electronic compounds.

The liquid crystal compositions are prepared in accordance with the ratios specified in the following Examples. The preparation of the liquid crystal compositions is proceeded by mixing in accordance with the ratios through conventional methods in the art, such as heating, ultrasonic wave, suspension and the like.

### Comparative Example 1

The liquid crystal composition of Comparative Example 1 is prepared according to each compound and weight percentage listed in Table 2 and is tested by filling the same between two substrates of a liquid crystal display device.

TABLE 2
Formulation and test results for performance
parameters of liquid crystal composition

| | | General | | |
|---|---|---|---|---|
| Component | Weight | formula | Test results for | |
| code | percentage | code | performance parameters | |
| 3LWO2 | 6 | C-1 | Δn | 0.11 |
| 3L1OWO2 | 4 | C-8 | Cp | 79 |
| 3CWPO2 | 4 | P-1 | Δε | −3.5 |
| 1VCWPO2 | 6 | P-1 | K₁₁ | 14.4 |
| 3CLWO2 | 5 | C-4 | K₃₃ | 15 |
| 4CLWO2 | 5 | C-4 | γ₁ | 86 |
| 5CLWO2 | 5 | C-4 | RT | 24.62 |
| 3CL1OWO2 | 4 | C-11 | Tr | 15.2 |
| 3PWO2 | 6 | N-14 | CR | 1442 |
| 3CCV | 33 | M-1 | t_{-40° C.} | 144 |
| 3CCV1 | 8 | M-1 | Flicker | −54 |
| VCCWO2 | 3 | N-7 | | |
| 3CCWO2 | 3 | N-7 | | |
| 4OB(S)O1 | 4 | | | |
| 4OB(S)O2 | 4 | | | |
| Total | 100 | | | |

### Example 1

The liquid crystal composition of Example 1 is prepared according to each compound and weight percentage listed in Table 3 and is tested by filling the same between two substrates of a liquid crystal display device.

TABLE 3
Formulation and test results for performance
parameters of liquid crystal composition

| | | General | | |
|---|---|---|---|---|
| | Weight | formula | Test results for | |
| Component code | percentage | code | performance parameters | |
| 3LWO2 | 6 | C-1 | Δn | 0.112 |
| 3L1OWO2 | 4 | C-8 | Cp | 80 |
| 3CWPO2 | 4 | P-1 | Δε | −3.7 |
| 1VCWPO2 | 6 | P-1 | K₁₁ | 16.2 |
| 3CLWO2 | 5 | C-4 | K₃₃ | 15.7 |
| 4CLWO2 | 5 | C-4 | γ₁ | 85 |
| 5CLWO2 | 5 | C-4 | RT | 23.11 |
| 3CL1OWO2 | 4 | C-11 | Tr | 16.8 |
| 3PWO2 | 6 | N-14 | CR | 1662 |
| 3CCV | 33 | M-1 | t_{-40° C.} | 216 |
| 3CCV1 | 8 | M-1 | Flicker | −65 |
| VCCWO2 | 3 | N-7 | | |
| 3CCWO2 | 3 | N-7 | | |
| 4OB(S)O1C(5, V) | 4 | B-5 | | |
| 4OB(S)OV(2F) | 4 | B-11 | | |
| Total | 100 | | | |

It can be seen from the comparison between Example 1 and Comparative Example 1 that, the liquid crystal composition of the present invention uses the combination of the compound of general formula B with the compounds of general formula P and general formula C, such that the liquid crystal composition of the present invention has a better optical anisotropy, a comparable clearing point, a better absolute value of dielectric anisotropy, a higher K value (K₁₁, K₃₃), a comparable rotational viscosity, a shorter response time, a higher transmittance, a higher contrast, a longer low-temperature storage time and a larger Flicker absolute value.

### Example 2

The liquid crystal composition of Example 2 is prepared according to each compound and weight percentage listed in Table 4 and is tested by filling the same between two substrates of a liquid crystal display device.

TABLE 4
Formulation and test results for performance
parameters of liquid crystal composition

| | | General | | |
|---|---|---|---|---|
| | Weight | formula | Test results for | |
| Component code | percentage | code | performance parameters | |
| 3LWO2 | 9 | C-1 | Δn | 0.111 |
| 3L1OWO2 | 4 | C-8 | Cp | 83 |
| 2CWPO2 | 4 | P-1 | Δε | −3.9 |
| 3CWPO2 | 6 | P-1 | K₁₁ | 16.5 |
| 1VCWPO2 | 4 | P-1 | K₃₃ | 16.9 |
| 3CLWO2 | 6 | C-4 | γ₁ | 88 |
| 3CL1OWO2 | 5 | C-11 | RT | 22.65 |
| 3CCV | 32 | M-1 | Tr | 16.5 |
| 1PP2V1 | 3 | M-4 | CR | 1716 |
| 3CCV1 | 7 | M-1 | t_{-40° C.} | 192 |
| VCCWO2 | 2 | N-7 | Flicker | −64 |
| 3CCWO2 | 2 | N-7 | | |
| 4OB(S)O1C(5, V) | 8 | B-5 | | |
| 2OB(S)O1C(5, V) | 8 | B-5 | | |
| Total | 100 | | | |

### Example 3

The liquid crystal composition of Example 3 is prepared according to each compound and weight percentage listed in Table 5 and is tested by filling the same between two substrates of a liquid crystal display device.

TABLE 5
Formulation and test results for performance
parameters of liquid crystal composition

| | | General | | |
|---|---|---|---|---|
| | Weight | formula | Test results for | |
| Component code | percentage | code | performance parameters | |
| 3LWO2 | 5 | C-1 | Δn | 0.113 |
| 3L1OWO2 | 4 | C-8 | Cp | 84 |
| 2CWPO2 | 7.5 | P-1 | Δε | −3.6 |
| 3CWPO2 | 9 | P-1 | K₁₁ | 15.5 |
| 1VCWPO2 | 5 | P-1 | K₃₃ | 17.4 |
| 3CLWO2 | 10 | C-4 | γ₁ | 84 |
| 3CL1OWO2 | 5 | C-11 | RT | 23.45 |
| 3PWO2 | 3 | N-14 | Tr | 16.3 |
| 1PP2V | 5 | M-4 | CR | 1636 |
| 3CCV | 30 | M-1 | t_{-40° C.} | 216 |
| V2CCP1 | 4.5 | M-11 | Flicker | −63 |
| 3CCWO2 | 3 | N-7 | | |
| 4OB(S)OV(2F) | 4.5 | B-11 | | |
| 2OB(S)OV(2F) | 4.5 | B-11 | | |
| Total | 100 | | | |

### Example 4

The liquid crystal composition of Example 4 is prepared according to each compound and weight percentage listed in Table 6 and is tested by filling the same between two substrates of a liquid crystal display device.

TABLE 6
Formulation and test results for performance
parameters of liquid crystal composition

| | | General | | |
|---|---|---|---|---|
| | Weight | formula | Test results for | |
| Component code | percentage | code | performance parameters | |
| 3LWO2 | 4 | C-1 | Δn | 0.11 |
| 3L1OWO2 | 4 | C-8 | Cp | 82 |
| 3CWPO2 | 5 | P-1 | Δε | −3.8 |
| 3CWPO2 | 5 | P-1 | K₁₁ | 15.8 |
| 3CWPO4 | 5 | P-1 | K₃₃ | 16.9 |
| 3CLWO2 | 5 | C-4 | γ₁ | 84 |
| 3CL1OWO2 | 3 | C-11 | RT | 22.45 |
| 3CCV | 37 | M-1 | Tr | 16.1 |
| 3CCV1 | 8 | M-1 | CR | 1708 |
| 3PWO2 | 4 | N-14 | t_{-40° C.} | 192 |
| 4OB(S)O1C(5, V) | 8 | B-5 | Flicker | −65 |
| 2OB(S)O1C(5, V) | 8 | B-5 | | |
| 4OB(S)OV(2F) | 2 | B-11 | | |
| 2OB(S)OV(2F) | 2 | B-11 | | |
| Total | 100 | | | |

### Example 5

The liquid crystal composition of Example 5 is prepared according to each compound and weight percentage listed in Table 7 and is tested by filling the same between two substrates of a liquid crystal display device.

TABLE 7
Formulation and test results for performance
parameters of liquid crystal composition

| | | General | | |
|---|---|---|---|---|
| | Weight | formula | Test results for | |
| Component code | percentage | code | performance parameters | |
| 3LWO2 | 7 | C-1 | Δn | 0.112 |
| 1VCWPO2 | 6 | P-1 | Cp | 80 |
| 3CWPO2 | 7 | P-1 | Δε | −3.6 |
| 3CWPO4 | 5 | P-1 | K₁₁ | 14.9 |
| 3CCWO2 | 10.5 | N-7 | K₃₃ | 15.3 |
| VCCWO2 | 5 | N-7 | γ₁ | 86 |
| 3PWO2 | 3 | N-14 | RT | 23.79 |
| 3CCV | 33 | M-1 | Tr | 16.3 |
| 3CCV1 | 6.5 | M-1 | CR | 1620 |
| 3PWP2 | 6 | N-19 | t_{-40° C.} | 168 |
| 1PGP2V | 3 | M-16 | Flicker | −61 |
| 4OB(S)O1C(5, V) | 4 | B-5 | | |
| 4OB(S)OV(2F) | 4 | B-11 | | |
| Total | 100 | | | |

### Example 6

The liquid crystal composition of Example 6 is prepared according to each compound and weight percentage listed in Table 8 and is tested by filling the same between two substrates of a liquid crystal display device.

TABLE 8
Formulation and test results for performance
parameters of liquid crystal composition

| Component | Weight | General | Test results for | |
|---|---|---|---|---|
| code | percentage | formula code | performance parameters | |
| 3LWO2 | 5 | C-1 | Δn | 0.114 |
| 2CWPO2 | 6 | P-1 | Cp | 83 |
| 3CWPO2 | 6 | P-1 | Δε | −3.7 |
| 1VCWPO2 | 6 | P-1 | K₁₁ | 15.7 |
| 3CLWO2 | 3 | C-4 | K₃₃ | 16.1 |
| 3PWO2 | 9 | N-14 | γ₁ | 85 |
| 3CPP2V | 5 | M-13 | RT | 22.34 |
| 3CPP2V1 | 3 | M-13 | Tr | 15.7 |
| 3CCV | 34 | M-1 | CR | 1622 |
| 3CCV1 | 8 | M-1 | t_{-40° C.} | 214 |
| 3CPO1 | 6 | M-2 | Flicker | −65 |
| VCCWO2 | 1.5 | N-7 | | |
| 3CCWO2 | 1.5 | N-7 | | |
| 4OB(S)OV(2F) | 3 | B-11 | | |
| 2OB(S)OV(2F) | 3 | B-11 | | |
| Total | 100 | | | |

### Example 7

The liquid crystal composition of Example 7 is prepared according to each compound and weight percentage listed in Table 9 and is tested by filling the same between two substrates of a liquid crystal display device.

TABLE 9
Formulation and test results for performance
parameters of liquid crystal

| Component | Weight | General | Test results for | |
|---|---|---|---|---|
| code | percentage | formula code | performance parameters | |
| 3CWO2 | 12 | N-2 | Δn | 0.11 |
| 1VCWPO2 | 3 | P-1 | Cp | 80 |
| 3CLWO2 | 5 | C-4 | Δε | −3.5 |
| 3CL1OWO2 | 2 | C-11 | K₁₁ | 15.5 |
| 3CCWO2 | 7 | N-7 | K₃₃ | 15.9 |
| VCCWO2 | 6 | N-7 | γ₁ | 83 |
| 3PWO2 | 7.5 | N-14 | RT | 23.65 |
| 3CCV | 33 | M-1 | Tr | 15.8 |
| 3CCV1 | 9.5 | M-1 | CR | 1598 |
| VCVCP1 | 5 | M-14 | t_{-40° C.} | 192 |
| 3CCEC3 | 4 | M-19 | Flicker | −61 |
| 4OB(S)OV(2F) | 3 | B-11 | | |
| 2OB(S)OV(2F) | 3 | B-11 | | |
| Total | 100 | | | |

### Example 8

The liquid crystal composition of Example 8 is prepared according to each compound and weight percentage listed in Table 10 and is tested by filling the same between two substrates of a liquid crystal display device.

TABLE 10
Formulation and test results for performance
parameters of liquid crystal composition

| Component | Weight | General | Test results for | |
|---|---|---|---|---|
| code | percentage | formula code | performance parameters | |
| 3CWO2 | 10.5 | N-2 | Δn | 0.112 |
| 3CLWO2 | 8 | C-4 | Cp | 83 |
| 3CL1OWO2 | 1.5 | C-11 | Δε | −3.6 |
| 3CWPO2 | 7 | P-1 | K₁₁ | 15.1 |
| 3CWPO4 | 6 | P-1 | K₃₃ | 15.7 |
| 3CCWO2 | 10 | N-7 | γ₁ | 84 |
| VCCWO2 | 4 | N-7 | RT | 24.02 |
| 3PWO2 | 5.5 | N-14 | Tr | 15.3 |
| 3CCV | 31 | M-1 | CR | 1547 |
| 3CCV1 | 4.5 | M-1 | t_{-40° C.} | 192 |
| 3CCP3 | 3 | M-11 | Flicker | −62 |
| 3CCP1 | 5 | M-11 | | |
| 4OB(S)OV(2F) | 4 | B-11 | | |
| Total | 100 | | | |

### Example 9

The liquid crystal composition of Example 9 is prepared according to each compound and weight percentage listed in Table 11 and is tested by filling the same between two substrates of a liquid crystal display device.

TABLE 11
Formulation and test results for performance
parameters of liquid crystal composition

| Component | Weight | General | Test results for | |
|---|---|---|---|---|
| code | percentage | formula code | performance parameters | |
| 3LWO2 | 5 | C-1 | Δn | 0.113 |
| 3CWPO2 | 4 | P-1 | Cp | 81 |
| 3CL1OWO2 | 5 | C-11 | Δε | −3.8 |
| 1VCWPO2 | 6 | P-1 | K₁₁ | 16.3 |
| 3CLWO2 | 7 | C-4 | K₃₃ | 15.4 |
| 4CLWO2 | 3 | C-4 | γ₁ | 85 |
| 3PWO2 | 10 | N-14 | RT | 22.16 |
| 3CCV | 33 | M-1 | Tr | 16.3 |
| 3CCV1 | 7 | M-1 | CR | 1595 |
| VCCP1 | 3 | M-11 | t_{-40° C.} | 192 |
| 3CC1OC3 | 5 | M-22 | Flicker | −62 |
| 3CCWO2 | 2 | N-7 | | |
| 3PPWO2 | 2 | N-18 | | |
| 5PPWO2 | 2 | N-18 | | |
| 4OB(S)O1C(5, V) | 6 | B-5 | | |
| Total | 100 | | | |

### Example 10

The liquid crystal composition of Example 10 is prepared according to each compound and weight percentage listed in Table 12 and is tested by filling the same between two substrates of a liquid crystal display device.

TABLE 12
Formulation and test results for performance
parameters of liquid crystal composition

| Component | Weight | General | Test results for | |
|---|---|---|---|---|
| code | percentage | formula code | performance parameters | |
| 3CWO2 | 8 | N-2 | Δn | 0.111 |
| 5CWO2 | 8 | N-2 | Cp | 85 |
| 3LWO2 | 5 | C-1 | Δε | −3.6 |
| 1VCWPO2 | 6 | P-1 | K₁₁ | 15.8 |
| 3CLWO2 | 7 | C-4 | K₃₃ | 16.1 |
| 4CLWO2 | 3 | C-4 | γ₁ | 89 |
| 3PWO2 | 6 | N-14 | RT | 24.39 |
| 3CCV | 37 | M-1 | Tr | 15.7 |
| 3CCV1 | 7 | M-1 | CR | 1595 |
| 3CGPC3 | 3 | M-25 | t_{-40° C.} | 168 |
| 3CL1OWO2 | 2 | C-11 | Flicker | −63 |
| 3PGWO2 | 2 | N-27 | | |
| 3OGWO2 | 2 | N-22 | | |
| 4OB(S)O1C(5, V) | 4 | B-5 | | |
| Total | 100 | | | |

The structures of polymerizable compounds used in the following Examples are shown in Table 13 below.

TABLE 13
Polymerizable compounds used in Examples

| | General |
|---|---|
| Structural formula | formula code |
| 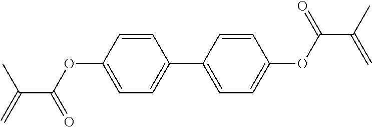 [SMILES: C=C(C)C(=O)Oc1ccc(-c2ccc(OC(=O)C(=C)C)cc2)cc1] | RM-1-1 |
| 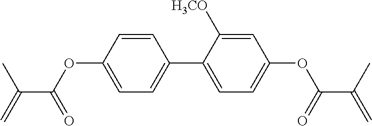 [SMILES: C=C(C)C(=O)Oc1ccc(-c2ccc(OC(=O)C(=C)C)cc2OC)cc1] | RM-13-5 |

The structures of additives used in the following Examples are shown in Table 14 below.

TABLE 14
Additives used in Examples

| | General |
|---|---|
| Structural formula | formula code |
| 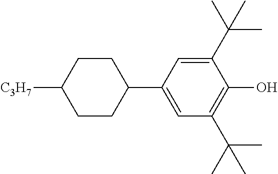 | T-3-1 |
| 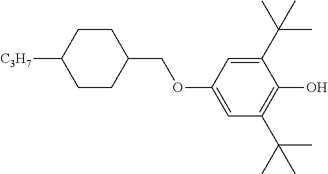 | T-4-1 |

Host liquid crystal compositions DH1, H3 and H4 are prepared according to each compound and weight percentage listed in Table 15 and are tested for performances by filling the same between two substrates of a liquid crystal display device.

TABLE 15
Formulation and test results for performance parameters
of host liquid crystal compositions

| Component | General | Weight percentage | | |
|---|---|---|---|---|
| code | formula code | DH1 | H3 | H4 |
| 3CPP2 | M-13 | 13 | 11 | 11 |
| 3CPPC3 | M-24 | 1 | | |
| 3C1OWO2 | N-5 | 11 | 11 | 10 |
| 2CC1OWO2 | N-10 | 8.5 | 6 | 6 |
| 3CC1OWO2 | N-10 | 9 | 11 | 10 |
| 3CC1 | M-1 | | 9 | 9 |
| 3CC2 | M-1 | 20 | | |
| 5CC2 | M-1 | | 6 | 6 |
| 4CC3 | M-1 | | 6 | 6 |
| 3CCP1 | M-11 | | 4 | 4 |
| 2CPP2 | M-13 | 8 | 7 | 7 |
| 5PP1 | M-4 | 14.5 | 11.5 | 11.5 |
| 2C1OWO2 | N-5 | 5 | 6.5 | 6.5 |
| 3CPWO2 | N-16 | 10 | | 4 |
| 3CWPO2 | P-1 | | 9 | 5 |
| C(5)1OB(O)O4 | | | 2 | 2 |
| 4OB(S)O1C(5, V) | B-5 | | | 2 |
| 4OB(S)O1THF | B-3 | | | |

| | | | |
|---|---|---|---|
| Total | 100 | 100 | 100 |
| Cp | 76.4 | 75.12 | 75.03 |
| Δn | 0.1128 | 0.109 | 0.1098 |
| Δε | −3.1 | −3.1 | −3.3 |
| K₁₁ | 13.2 | 13.2 | 13.4 |
| K₃₃ | 15.2 | 13.5 | 13.7 |
| γ₁ | 75 | 73 | 72 |

Host liquid crystal compositions DH3, DH4, H5, H6, H7, H8, H9 and H10 are prepared according to each compound and weight percentage listed in Table 16 and are tested for performances by filling the same between two substrates of a liquid crystal display device.

TABLE 16
Formulation and test results for performance parameters of host liquid crystal compositions

| | General | | | | | | | | |
|---|---|---|---|---|---|---|---|---|---|
| Component | formula | Weight percentage | | | | | | | |
| code | code | DH3 | DH4 | H5 | H6 | H7 | H8 | H9 | H10 |
| 3CPP2 | M-13 | 11 | 9 | 11 | 11 | 11 | 9 | 9 | 9 |
| 3C1OWO2 | N-5 | 11 | | 7 | 11 | | | | |
| 2CC1OWO2 | N-10 | 6 | | 6 | 6 | 6 | | | |
| 3CC1OWO2 | N-10 | 11 | | 11 | 9 | 9 | | | |
| 3CWO2 | N-2 | | 8 | | | | 8 | 8 | 8 |
| 2CCWO2 | N-7 | | 5 | | | | 5 | 5 | 5 |
| 3CCWO2 | N-7 | | 10 | | | | 9 | 9 | 9 |
| 3CC1 | M-1 | 9 | 9 | 9 | 9 | 9 | 9 | 9 | 9 |
| 5CC2 | M-1 | 6 | | 6 | 6 | 6 | | | |
| 4CC3 | M-1 | 6 | 8 | 6 | 6 | 6 | 8 | 8 | |
| 3CCP1 | M-11 | 4 | | 4 | 4 | 4 | | | |
| 2CPP2 | M-13 | 7 | 5 | 7 | 7 | 7 | 5 | 5 | 5 |
| 5PP1 | M-4 | 11.5 | 10 | 11.5 | 11.5 | 11.5 | 10 | 10 | 10 |
| 2C1OWO2 | N-5 | 6.5 | | 6.5 | 6.5 | 6.5 | | | |
| 2CWO2 | N-2 | | 4 | | | | 4 | 4 | 4 |
| 3CPWO2 | N-16 | 9 | 9 | | | | | | |
| 3CWPO2 | P-1 | | | 9 | 5 | 9 | 9 | 5 | 9 |
| 2OG′WO2 | N-23 | | | 4 | 4 | 5 | | | |
| 3PWO2 | N-14 | | 4 | | | 6 | 4 | 4 | 4 |
| 2OPWO2 | N-14 | | | | 2 | | | | |
| 2OGWO2 | N-22 | | 3 | | | | 3 | 3 | 3 |
| 4OB(S)O1C(5,V) | B-5 | 2 | 8 | 2 | 2 | 2 | 8 | 8 | 8 |
| 2OB(S)OV(2F) | B-11 | | 8 | | | 2 | 8 | 8 | 8 |
| 3CLWO2 | C-4 | | | | | | 1 | 1 | 1 |
| 3CCV1 | M-1 | | | | | | | | 8 |
| 1VCPWO2 | N-16 | | | | | | | 4 | |
| Total | | 100 | 100 | 100 | 100 | 100 | 100 | 100 | 100 |
| Cp | | 75.12 | 75.8 | 75.2 | 75.1 | 75.5 | 75.8 | 76 | 76.5 |
| Δn | | 0.109 | 0.110 | 0.109 | 0.109 | 0.109 | 0.111 | 0.112 | 0.113 |
| Δε | | −3.0 | −3.1 | −3.0 | −2.9 | −3.0 | −3.1 | −3.1 | −3.1 |
| K₁₁ | | 13.2 | 13.7 | 13.1 | 13.2 | 13.3 | 13.7 | 14 | 14.2 |
| K₃₃ | | 13.5 | 13.6 | 13.5 | 13.5 | 13.5 | 13.6 | 13.8 | 14.1 |
| γ₁ | | 76 | 78 | 73 | 72 | 71 | 77 | 78 | 78 |

### Comparative Examples 2-3 and Examples 11-12

The liquid crystal compositions of Comparative Example 2, Comparative Example 4 and Examples 11-12 are prepared according to the parts by weight of each component in Table 17. The physical properties of each liquid crystal composition obtained show almost no change relative to respective host liquid crystal composition. The obtained liquid crystal compositions are filled into test cells respectively for performance testing. The test results of relevant performances of the liquid crystal compositions of Comparative Examples 2-3 and Examples 11-12 are shown in Table 17 below.

TABLE 17
Formulation and test results for performance
parameters of liquid crystal

| | Comp. Exp. 2 | Comp. Exp. 3 | Exp. 11 | Exp. 12 |
|---|---|---|---|---|
| DH1 | 100 | 100 | | |
| H3 | | | 100 | |
| H4 | | | | 100 |
| RM-1-1 | 0.3 | 0.3 | 0.3 | 0.3 |
| T-3-1 | 0.02 | | 0.02 | 0.02 |
| T-4-1 | | 0.01 | | |
| Ra | 156 | 153 | 120 | 119 |
| PTA₍ᵢₙᵢₜᵢₐₗ₎ | 88.45 | 88.62 | 88.45 | 88.68 |
| PTA_{(168 h)} | 88.13 | 88.31 | 88.19 | 88.41 |
| ΔPTA_{(168 h)} | 0.32 | 0.31 | 0.26 | 0.27 |
| residue | 14.5 | 14.1 | 13.2 | 13.3 |
| concentration | | | | |
| VHR | 93.4 | 93.2 | 94.2 | 94.1 |

It can be seen from the comparison between Examples 11-12 and Comparative Examples 2-3 that, the present invention uses the combination of the compound of general formula P, the compound of general formula B and the polymerizable compound of general formula RM, such that the liquid crystal composition of the present invention has an appropriate clearing point, an appropriate optical anisotropy, an appropriate absolute value of dielectric anisotropy, an appropriate K value (K₁₁, K₃₃), an appropriate rotational viscosity, a smaller roughness, a better pre-tilt angle stability, a lower residue concentration and a higher VHR stability.

### Comparative Examples 4-6 and Examples 13-18

The liquid crystal compositions of Comparative Examples 4-6 and Examples 13-18 are prepared according to the parts by weight of each component in Table 18. The physical properties of each liquid crystal composition obtained show almost no change relative to respective host liquid crystal composition. The obtained liquid crystal compositions are filled into test cells respectively for performance testing. The test results of relevant performances of the liquid crystal compositions of Comparative Examples 4-6 and Examples 13-18 are shown in Table 18 below.

TABLE 18
Formulation and test results for performance parameters of liquid crystal

| | Comp. | Comp. | Comp. | Exp. | Exp. | Exp. | Exp. | Exp. | Exp. |
|---|---|---|---|---|---|---|---|---|---|
| | Exp. 4 | Exp. 5 | Exp. 6 | 13 | 14 | 15 | 16 | 17 | 18 |
| DH3 | 100 | 100 | 100 | | | | | | |
| H3 | | | | 100 | | | | | |
| H4 | | | | | 100 | 100 | | | |
| H5 | | | | | | | 100 | | |
| H6 | | | | | | | | 100 | |
| H7 | | | | | | | | | 100 |
| RM-1-1 | 0.3 | | 0.3 | 0.3 | 0.3 | | 0.3 | 0.3 | 0.3 |
| RM-2-1 | | 0.26 | | | | 0.26 | | | |
| T-3-1 | 0.02 | 0.02 | | 0.02 | | | | 0.02 | 0.02 |
| T-4-1 | | | 0.01 | | 0.01 | 0.01 | 0.01 | | |
| Ra | 134 | 133 | 133 | 120 | 118 | 115 | 118 | 116 | 118 |
| PTA₍ᵢₙᵢₜᵢₐₗ₎ | 88.34 | 88.26 | 88.41 | 88.15 | 88.48 | 88.34 | 88.19 | 88.54 | 88.15 |
| PTA_{(168 h)} | 88.03 | 87.95 | 88.1 | 87.89 | 88.23 | 88.09 | 87.92 | 88.28 | 87.89 |
| ΔPTA_{(168 h)} | 0.31 | 0.31 | 0.31 | 0.26 | 0.25 | 0.25 | 0.27 | 0.26 | 0.26 |
| residue | 14.5 | 14.3 | 13.5 | 13.4 | 13.4 | 13.3 | 13.4 | 13.5 | 13.4 |
| concentration | | | | | | | | | |
| VHR | 93.4 | 93.3 | 93.4 | 94 | 94.1 | 94 | 94 | 94.1 | 94 |

It can be seen from the comparison between Examples 13-18 and Comparative Examples 4-6 that, the present invention uses the combination of the compound of general formula P, the compound of general formula B and the polymerizable compound of general formula RM, such that the liquid crystal composition of the present invention has an appropriate clearing point, an appropriate optical anisotropy, an appropriate absolute value of dielectric anisotropy, an appropriate K value (K₁₁, K₃₃) an appropriate rotational viscosity, a smaller roughness, a better pre-tilt angle stability, a lower residue concentration and a higher VHR stability. It can be seen from the comparison between Example 16 and Comparative Example 6 that, the present invention uses the combination of the compound of general formula P, the compound of general formula B, the polymerizable compound of general formula RM, and the compound of general formula N-23 and/or the compound of general formula N-22, such that the liquid crystal composition of the present invention has a relatively smaller roughness, a better pre-tilt angle stability, a lower residue concentration and a higher VHR stability.

### Comparative Examples 7-9 and Examples 19-24

The liquid crystal compositions of Comparative Examples 7-9 and Examples 19-24 are prepared according to the parts by weight of each component in Table 19. The physical properties of each liquid crystal composition obtained show almost no change relative to respective host liquid crystal composition. The obtained liquid crystal compositions are filled into test cells respectively for performance testing. The test results of relevant performances of the liquid crystal compositions of Comparative Examples 7-9 and Examples 19-24 are shown in Table 19_below.

TABLE 19
Formulation and test results for performance parameters of liquid crystal composition

| | Comp. | Comp. | Comp. | Exp. | Exp. | Exp. | Exp. | Exp. | Exp. |
|---|---|---|---|---|---|---|---|---|---|
| | Exp. 7 | Exp. 8 | Exp. 9 | 19 | 20 | 21 | 22 | 23 | 24 |
| DH3 | 100 | | | | | | | | |
| DH4 | | 100 | 100 | | | | | | |
| H5 | | | | 100 | | | | | |
| H6 | | | | | 100 | | | | |
| H7 | | | | | | 100 | | | |
| H8 | | | | | | | 100 | | |
| H9 | | | | | | | | 100 | |
| H10 | | | | | | | | | 100 |
| RM-1-1 | | | 0.3 | | | | | | |
| RM-2-1 | 0.26 | 0.26 | | 0.26 | 0.26 | 0.26 | 0.26 | 0.26 | 0.26 |
| T-3-1 | | | 0.02 | 0.02 | | | 0.02 | 0.02 | |
| T-4-1 | 0.01 | 0.01 | | | 0.01 | 0.01 | | | 0.01 |
| Ra | 120 | 131 | 134 | 114 | 115 | 113 | 116 | 116 | 112 |
| PTA₍ᵢₙᵢₜᵢₐₗ₎ | 88.45 | 88.34 | 88.37 | 88.08 | 88.22 | 88.17 | 88.56 | 88.52 | 88.35 |
| PTA_{(168 h)} | 88.1 | 87.99 | 88.04 | 87.81 | 87.96 | 87.91 | 88.29 | 88.26 | 88.08 |
| ΔPTA_{(168 h)} | 0.35 | 0.35 | 0.33 | 0.27 | 0.26 | 0.26 | 0.27 | 0.26 | 0.27 |
| residue | 14.1 | 14.3 | 14.1 | 13.3 | 13.4 | 13.4 | 13.6 | 13.4 | 13.4 |
| concentration | | | | | | | | | |
| VHR | 93.5 | 93.3 | 93.1 | 93.9 | 94.1 | 94.2 | 94.2 | 94.1 | 94.2 |

It can be seen from the comparison between Examples 19-24 and Comparative Examples 7-9 that, the present invention uses the combination of the compound of general formula P, the compound of general formula B and the polymerizable compound of general formula RM, such that the liquid crystal composition of the present invention has an appropriate clearing point, an appropriate optical anisotropy, an appropriate absolute value of dielectric anisotropy, an appropriate K value (K₁₁, K₃₃), an appropriate rotational viscosity, a smaller roughness, a better pre-tilt angle stability, a lower residue concentration and a higher VHR stability.

### Comparative Example 10

The liquid crystal composition of Comparative Example 10 is prepared according to each compound and weight percentage listed in Table 20 and is tested by filling the same between two substrates of a liquid crystal display device.

TABLE 20
Formulation and test results for performance
parameters of liquid crystal composition

| Component | Weight | General | Test results for | |
|---|---|---|---|---|
| code | percentage | formula code | performance parameters | |
| 3CWO2 | 7.5 | N-2 | Δn | 0.1 |
| 2CCWO2 | 9.5 | N-7 | Cp | 101 |
| 3CCWO2 | 8 | N-7 | ε⊥ | 6.2 |
| 4CCWO2 | 8 | N-7 | Kₐᵥₑ | 15.3 |
| 2CWPO2 | 5 | P-1 | Flicker | −54 |
| 3CWPO2 | 5 | P-1 | | |
| 3PWP2 | 3.5 | N-19 | | |
| 4PWP3 | 4 | N-19 | | |
| 4PG′WO2 | 1.5 | N-26 | | |
| 2OB(S)O3 | 2 | | | |
| 4OB(S)O3 | 2 | | | |
| 3CCV | 31 | M-1 | | |
| 3CCV1 | 10 | M-1 | | |
| VCCP1 | 3 | M-11 | | |
| Total | 100 | | | |

### Example 25

The liquid crystal composition of Example 25 is prepared according to each compound and weight percentage listed in Table 21 and is tested by filling the same between two substrates of a liquid crystal display device.

TABLE 21
Formulation and test results for performance
parameters of liquid crystal composition

| Component | Weight | General | Test results for | |
|---|---|---|---|---|
| code | percentage | formula code | performance parameters | |
| 3CWO2 | 7.5 | N-2 | Δn | 0.102 |
| 2CCWO2 | 9.5 | N-7 | Cp | 103 |
| 3CCWO2 | 8 | N-7 | ε⊥ | 6.6 |
| 4CCWO2 | 8 | N-7 | Kₐᵥₑ | 15.8 |
| 2CWPO2 | 5 | P-1 | Flicker | −60 |
| 3CWPO2 | 5 | P-1 | | |
| 3PPWO2 | 2.5 | N-18 | | |
| 3PG′WO2 | 1.5 | N-26 | | |
| 3P2PWO2 | 5 | N-12 | | |
| 2OB(S)OV(2F) | 2 | B-11 | | |
| 2OB(S)O1C(S, V) | 2 | B-5 | | |
| 3CCV | 31 | M-1 | | |
| 3CCV1 | 10 | M-1 | | |
| VCCP1 | 3 | M-11 | | |
| Total | 100 | | | |

### Comparative Example 11

The liquid crystal composition of Comparative Example 11 is prepared according to each compound and weight percentage listed in Table 22 and is tested by filling the same between two substrates of a liquid crystal display device.

TABLE 22
Formulation and test results for performance
parameters of liquid crystal

| Component | Weight | General | Test results for | |
|---|---|---|---|---|
| code | percentage | formula code | performance parameters | |
| 3PWO2 | 12.5 | N-14 | Δn | 0.098 |
| 2CCWO2 | 9.5 | N-7 | Cp | 100 |
| 3CCWO2 | 7 | N-7 | ε⊥ | 5.9 |
| 3CC1OWO2 | 6 | N-10 | Kₐᵥₑ | 15.1 |
| 4CCWO2 | 5 | N-7 | Flicker | −52 |
| 3CWPO2 | 6 | P-1 | | |
| 2CWPO2 | 4 | P-1 | | |
| 3PWP2 | 3 | N-19 | | |
| 3PG′WO2 | 2 | N-26 | | |
| 3CCV | 30 | M-1 | | |
| 3CCV1 | 10 | M-1 | | |
| VCCP1 | 5 | M-11 | | |
| Total | 100 | | | |

### Example 26

The liquid crystal composition of Example 26 is prepared according to each compound and weight percentage listed in Table 23 and is tested by filling the same between two substrates of a liquid crystal display device.

TABLE 23
Formulation and test results for performance
parameters of liquid crystal composition

| Component | Weight | General | Test results for | |
|---|---|---|---|---|
| code | percentage | formula code | performance parameters | |
| 3PWO2 | 6.5 | N-14 | Δn | 0.101 |
| 2CCWO2 | 5.5 | N-7 | Cp | 104 |
| 3CCWO2 | 7 | N-7 | ε⊥ | 7 |
| 3CC1OWO2 | 6 | N-10 | Kₐᵥₑ | 16.4 |
| 4CCWO2 | 5 | N-7 | Flicker | −62 |
| 3CWPO2 | 6 | P-1 | | |
| 2CWPO2 | 4 | P-1 | | |
| 3PPWO2 | 3 | N-18 | | |
| 3PG′WO2 | 2 | N-26 | | |
| 2OB(S)OV(2F) | 3 | B-11 | | |
| 4OB(S)OV(2F) | 3 | B-11 | | |
| 2OB(S)O1C(5, V) | 4 | B-5 | | |
| 3CCV | 30 | M-1 | | |
| 3CCV1 | 10 | M-1 | | |
| VCCP1 | 5 | M-11 | | |
| Total | 100 | | | |

### Example 27

The liquid crystal composition of Example 27 is prepared according to each compound and weight percentage listed in Table 24 and is tested by filling the same between two substrates of a liquid crystal display device.

TABLE 24
Formulation and test results for performance
parameters of liquid crystal composition

| Component | Weight | General | Test results for | |
|---|---|---|---|---|
| code | percentage | formula code | performance parameters | |
| 3CWO2 | 4.5 | N-14 | Δn | 0.101 |
| 2CCWO2 | 7.5 | N-7 | Cp | 102 |
| 3CC1OWO2 | 6 | N-10 | ε⊥ | 7 |
| 3CWPO2 | 8 | P-1 | Kₐᵥₑ | 16.5 |
| 3CWPO3 | 8 | P-1 | Flicker | −62 |
| 2CWPO2 | 6 | P-1 | | |
| 3PPWO2 | 3 | N-18 | | |
| 3PG′WO2 | 2 | N-26 | | |
| 3CWO2 | 3 | N-2 | | |
| 4OB(S)OV(2F) | 3 | B-11 | | |
| 2OB(S)O1C(5, V) | 4 | B-5 | | |
| 3CCV | 34 | M-1 | | |
| 3CPO1 | 2 | M-2 | | |
| 3CCP1 | 7 | M-11 | | |
| 3CPP2V | 2 | M-13 | | |
| Total | 100 | | | |

### Example 28

The liquid crystal composition of Example 28 is prepared according to each compound and weight percentage listed in Table 25 and is tested by filling the same between two substrates of a liquid crystal display device.

TABLE 25
Formulation and test results for performance
parameters of liquid crystal composition

| Component | Weight | General | Test results for | |
|---|---|---|---|---|
| code | percentage | formula code | performance parameters | |
| 3CWO2 | 3 | N-2 | Δn | 0.104 |
| 2CCWO2 | 6 | N-7 | Cp | 104 |
| 3CC1OWO2 | 6 | N-10 | ε⊥ | 7.5 |
| 3CWPO2 | 4 | P-1 | Kₐᵥₑ | 17.3 |
| 3CWPO3 | 5 | P-1 | Flicker | −64 |
| 2CWPO2 | 3 | P-1 | | |
| 3PPWO2 | 3 | N-18 | | |
| 3PPWO4 | 2 | N-18 | | |
| 5PPWO2 | 2 | N-18 | | |
| 3PG′WO2 | 5 | N-26 | | |
| 3P2PWO2 | 5 | N-12 | | |
| 3P2PWO4 | 3 | N-12 | | |
| 4OB(S)OV(2F) | 4 | B-11 | | |
| 2OB(S)O1C(5, V) | 4 | B-5 | | |
| 3CCV | 33 | M-1 | | |
| 3CCV1 | 10 | M-1 | | |
| V2CCP1 | 2 | M-11 | | |
| Total | 100 | | | |

### Example 29

The liquid crystal composition of Example 29 is prepared according to each compound and weight percentage listed in Table 26 and is tested by filling the same between two substrates of a liquid crystal display device.

TABLE 26
Formulation and test results for performance
parameters of liquid crystal composition

| Component | Weight | General | Test results for | |
|---|---|---|---|---|
| code | percentage | formula code | performance parameters | |
| 2CCWO2 | 3.5 | N-7 | Δn | 0.104 |
| 3CCWO2 | 5 | N-7 | Cp | 102 |
| 3CC1OWO2 | 4 | N-10 | ε⊥ | 8.2 |
| 4CCWO2 | 5 | N-7 | Kₐᵥₑ | 17 |
| 3CWPO2 | 4 | P-1 | Flicker | −64 |
| 2CWPO2 | 5 | P-1 | | |
| 3PPWO2 | 3 | N-18 | | |
| 3PG′WO2 | 5 | N-26 | | |
| 2OB(S)OV(2F) | 4 | B-11 | | |
| 4OB(S)OV(2F) | 4 | B-11 | | |
| 2OB(S)O1C(5, V) | 6 | B-5 | | |
| 4OB(S)O1C(5, V) | 6.5 | B-5 | | |
| 3CCV | 35 | M-1 | | |
| 4CC3 | 4 | M-1 | | |
| 3CC10C3 | 4.5 | M-22 | | |
| 3CPPC3 | 1.5 | M-24 | | |
| Total | 100 | | | |

### Example 30

The liquid crystal composition of Example 30 is prepared according to each compound and weight percentage listed in Table 27 and is tested by filling the same between two substrates of a liquid crystal display device.

TABLE 27
Formulation and test results for performance
parameters of liquid crystal composition

| Component | Weight | General | Test results for | |
|---|---|---|---|---|
| code | percentage | formula code | performance parameters | |
| 3CWO2 | 3 | N-2 | Δn | 0.108 |
| 2CCWO2 | 4 | N-7 | Cp | 105 |
| 2CWPO2 | 6 | P-1 | ε⊥ | 7.7 |
| 3CWPO2 | 6 | P-1 | Kₐᵥₑ | 17.4 |
| 1VCWPO3 | 6 | P-1 | Flicker | −65 |
| VCWPO2 | 6 | P-1 | | |
| 3CWPO4 | 6 | P-1 | | |
| 3PPWO2 | 3 | N-18 | | |
| 3PPWO4 | 2 | N-18 | | |
| 3PG′WO2 | 4 | N-26 | | |
| 3P2PWO2 | 4 | N-12 | | |
| 4OB(S)OV(2F) | 5 | B-11 | | |
| 2OB(S)O1C(5, V) | 5 | B-5 | | |
| 3CCV | 30 | M-1 | | |
| 3CC2 | 8 | M-1 | | |
| 1PP2V1 | 2 | M-4 | | |
| Total | 100 | | | |

It can be seen from Examples 25-30 and Comparative Examples 10-11 that, the liquid crystal composition of the present invention has a better optical anisotropy, a higher clearing point, a larger Kₐᵥₑ value and a larger Flicker absolute value, such that the liquid crystal display device comprising the same has a better contrast as well as less flicker and a better screen display effect.

The above embodiments are merely illustrative of the technical concepts and the features of the present invention, are included merely for purposes of illustration and implement of the present invention, and are not intended to limit the scope of the present invention. Equivalent variations or modifications are intended to be included within the scope of the present invention.

1. A liquid crystal composition comprising:
at least one compound of general formula P: 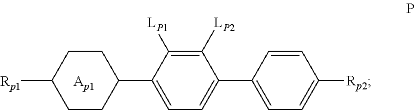
and
at least one compound of general formula B: 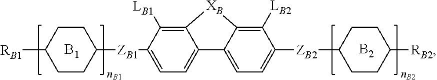
wherein,
Rₚ₁, Rₚ₂ and R_{B1} each independently represents C₁₋₁₂ linear alkyl, C₃₋₁₂ branched alkyl, 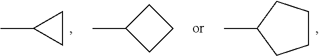
wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
R_{B2} represents —F, —Cl, —CF₃, —OCF₃, 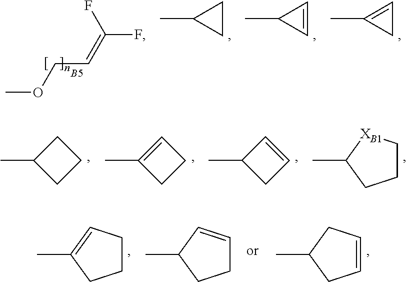
wherein one or more than two nonadjacent —CH₂— in 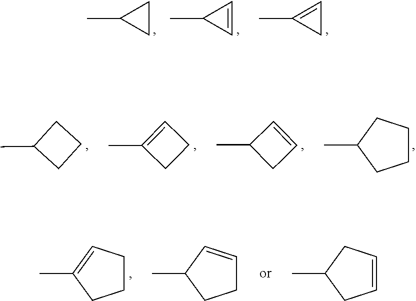
can each be independently replaced by —O—, —S—, —CO—, —CO—O— or —O—CO—, wherein, X_{B1} represents —O— or —S, n_{B5} represents an integer of 0-5;
ring 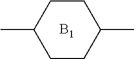
and ring 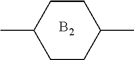
each independently represents, 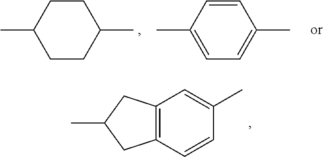
wherein one or more —CH₂— in 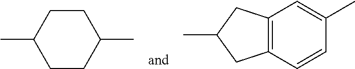
can each be independently replaced by —O— or —S—, and one or at most two single bonds in the rings can be replaced by double bond, wherein one or more —H on 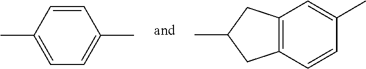
can each be independently substituted by —CN, —F or —Cl, and one or more —CH═ in the rings can be replaced by —N═;
ring 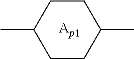
represents 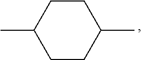
wherein one or more —CH₂— in 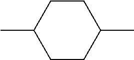
can be replaced by —O—, and one or at most two single bonds in the ring can be replaced by double bond;
X_{B} represents —O—, —S— or —CO—;
Lₚ₁ and Lₚ₂ each independently represents halo;
L_{B1} and L_{B2} each independently represents —H, —F, —Cl, —CF₃ or —OCF₃;
Z_{B1} and Z_{B2} each independently represents —CO—O—, —O—CO—, —OCH₂—, —CH═CH—, —C≡C—, —CH₂CH₂—, —CF₂CF₂—, —(CH₂)n_{B4}-, —(CH₂)n_{B4}O—, —O(CH₂)n_{B4}-, —(CH₂)n_{B4}S—, —S(CH₂)n_{B4}-, —CF₂O— or —OCF₂—, wherein n_{B4} represents an integer of 0-5; and
n_{B1} and n_{B2} each independently represents 0, 1 or 2, wherein when n_{B1} represents 2, ring 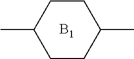
can be the same or different, and wherein when n_{B2} represents 2, ring 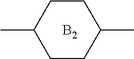
can be the same or different.

2. The liquid crystal composition according to claim 1, wherein the liquid crystal composition further comprises at least one compound of general formula C 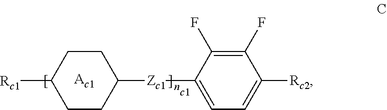
wherein,
R_{c1} and R_{c2} each independently represents C₁₋₁₂ linear alkyl, C₃₋₁₂ branched alkyl, 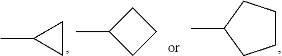
wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring 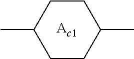
represents 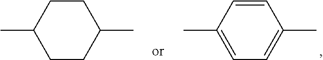
wherein one or more —CH₂— in 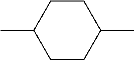
can be replaced by —O—, and one or at most two single bonds in the ring can be replaced by double bond, and wherein one or more —H on 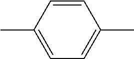
can each be independently substituted by —F, —Cl or —CN, and one or more —CH═ in the ring can be replaced by —N═; wherein at least one ring 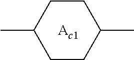
in general formula C represents 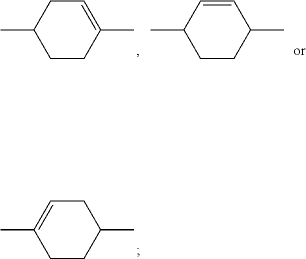
Z_{c1} represents —CO—O—, —O—CO—, —OCH₂—, —CH═CH—, —C≡C—, —CH₂CH₂—, —CF₂CF₂—, —(CH₂)n_{B4}-, —(CH₂)n_{B4}O—, —O(CH₂)n_{B4}-, —(CH₂)n_{B4}S—, —S(CH₂)n_{B4}-, —CF₂O— or —OCF₂—, wherein n_{B4} represents an integer of 0-5; and
n_{c1} represents 1, 2 or 3, when n_{c1}=2 or 3, ring 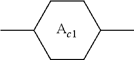
can be the same or different, Z_{c1} can be the same or different.

3. The liquid crystal composition according to claim 2, wherein the compound of general formula P is selected from a group consisting of the following compounds: 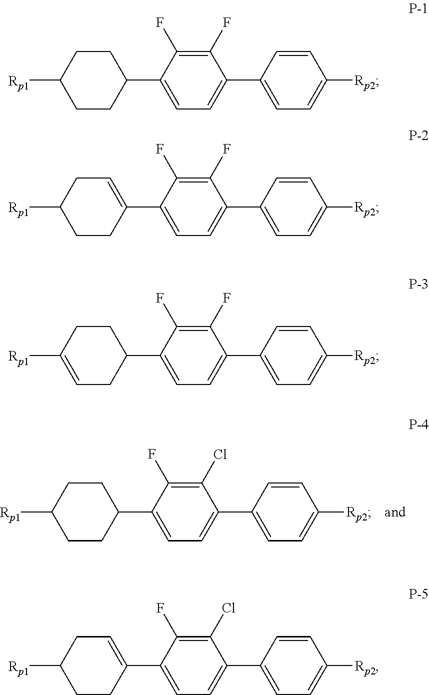
the compound of general formula B is selected from a group consisting of the following compounds: 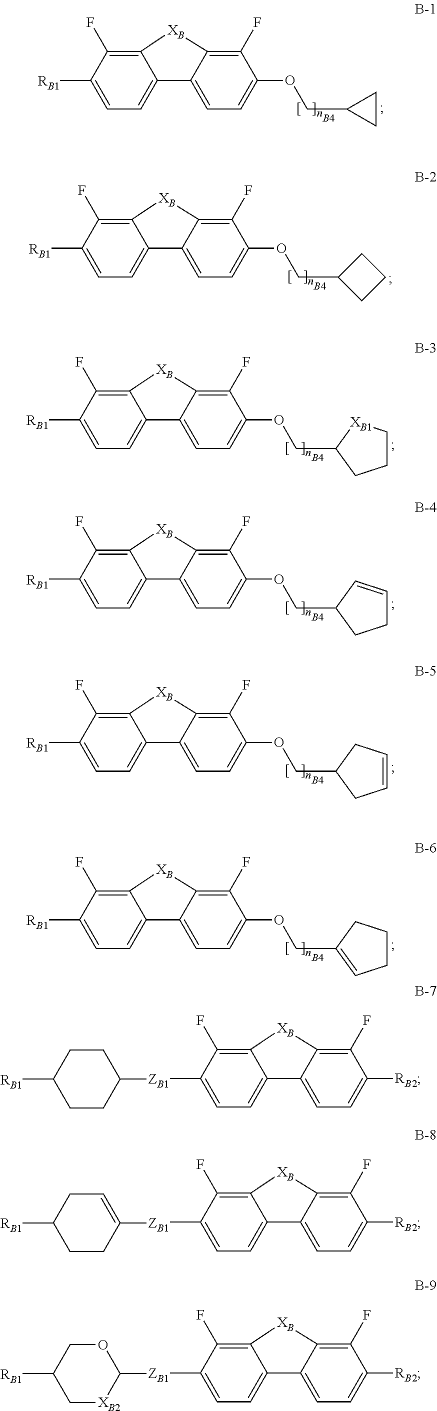 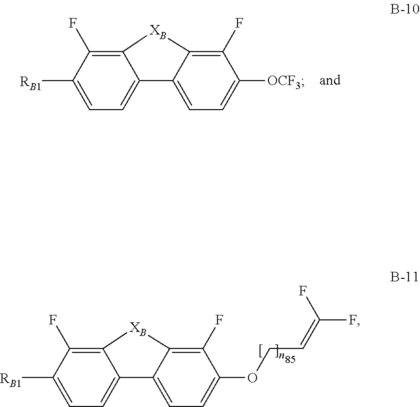
the compound of general formula C is selected from a group consisting of the following compounds: 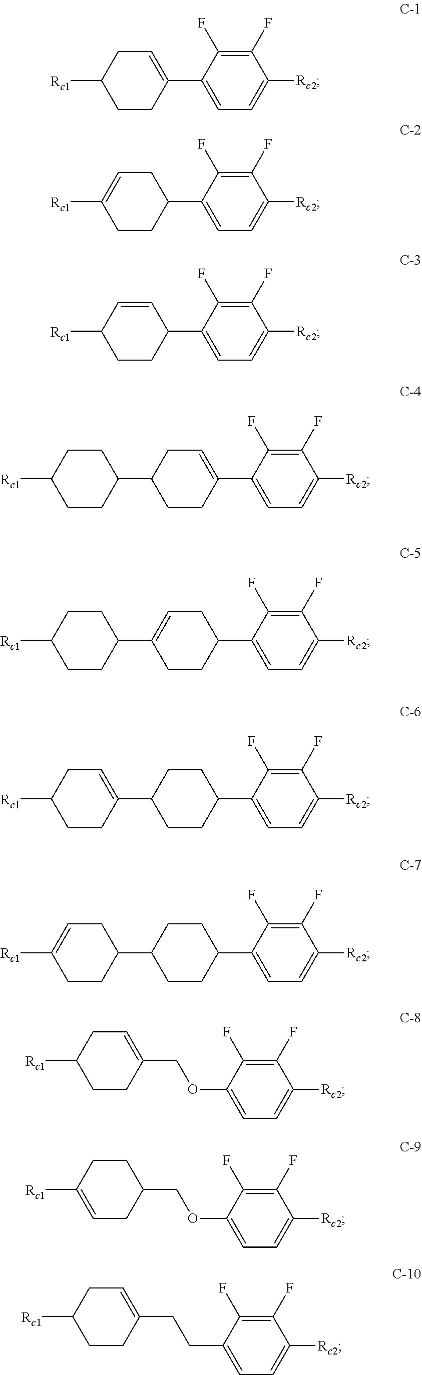 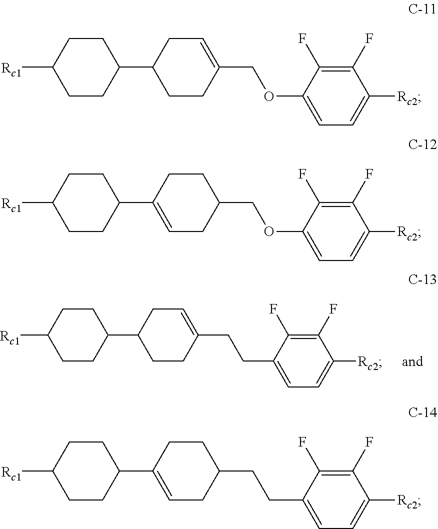
wherein,
X_{B2} represents —O—, —S— or —CH₂—.

4. The liquid crystal composition according to claim 2, wherein the compound of general formula P provides 0.1%-30% by weight of the liquid crystal composition, the compound of general formula B provides 0.1%-30% by weight of the liquid crystal composition, and the compound of general formula C provides 0.1%-40% by weight of the liquid crystal composition.

5. The liquid crystal composition according to claim 1, wherein the liquid crystal composition further comprises at least one compound of general formula N: 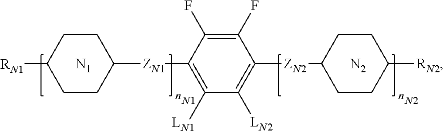
wherein,
R_{N1} and R_{N2} each independently represents C₁₋₁₂ linear alkyl, C₃₋₁₂ branched alkyl, 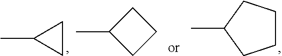
wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring 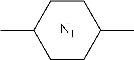
and ring 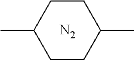
each independently represents 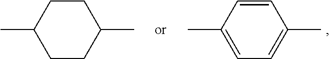
wherein one or more —CH₂— in 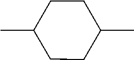
can be replaced by —O—, wherein one or more —H on 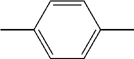
can each be independently substituted by —F, —Cl or —CN, and one or more —CH═ in the ring can be replaced by —N═;
L_{N1} and L_{N2} each independently represents —H, C₁₋₃ alkyl or halo;
Z_{N1} and Z_{N2} each independently represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n_{N1} represents 0, 1, 2 or 3, n_{N2} represents 0 or 1, and 0≤n_{N1}+n_{N2}≤3, when n_{N1}=2 or 3, ring 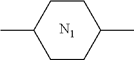
can be the same or different, Z_{N1} can be the same or different; and
when n_{N1} represents 1, and ring 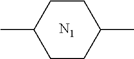
represents 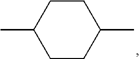
n_{N2}=0.

6. The liquid crystal composition according to claim 5, wherein the compound of general formula N is selected from a group consisting of the following compounds:

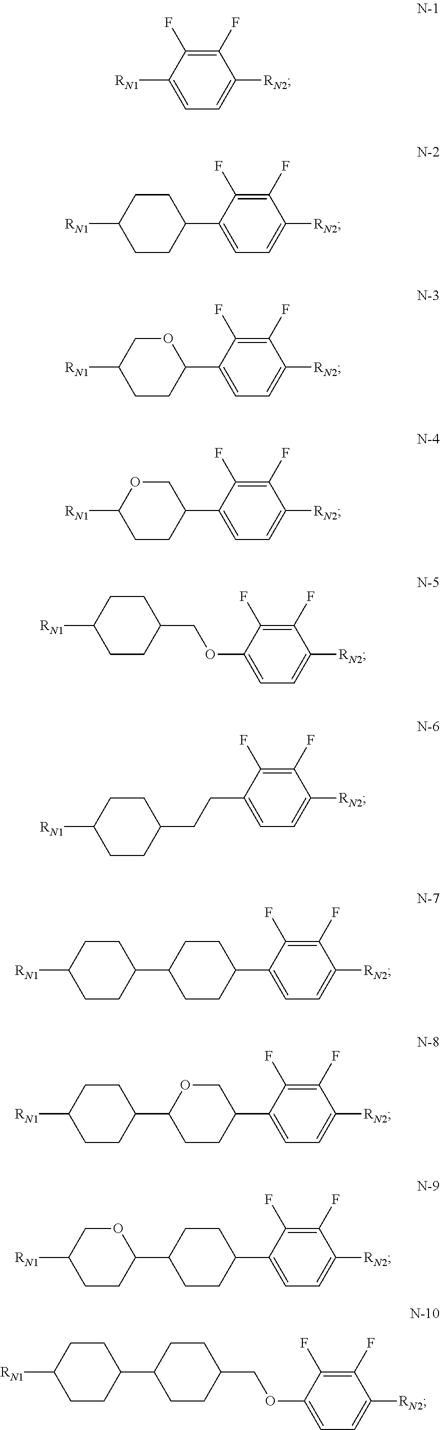

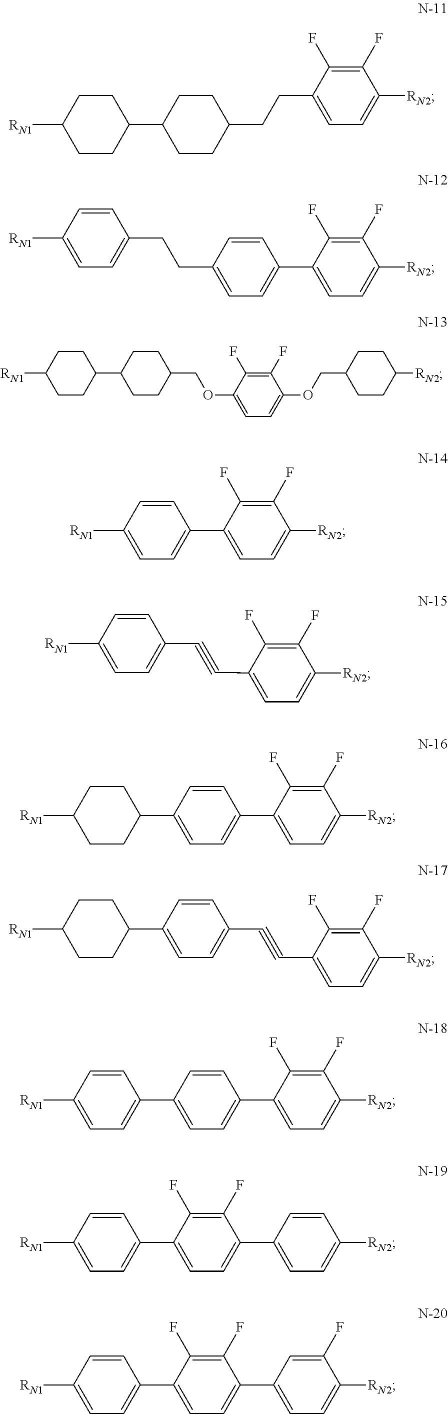

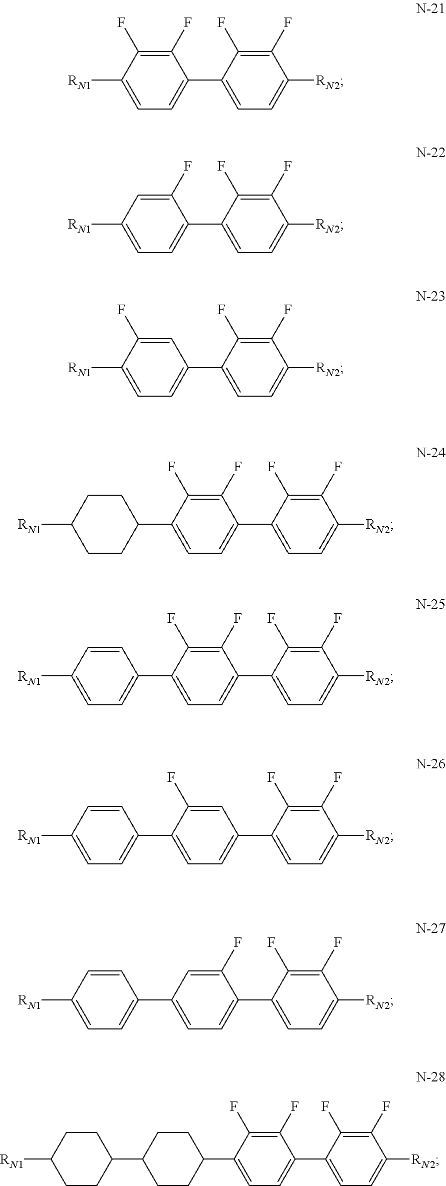

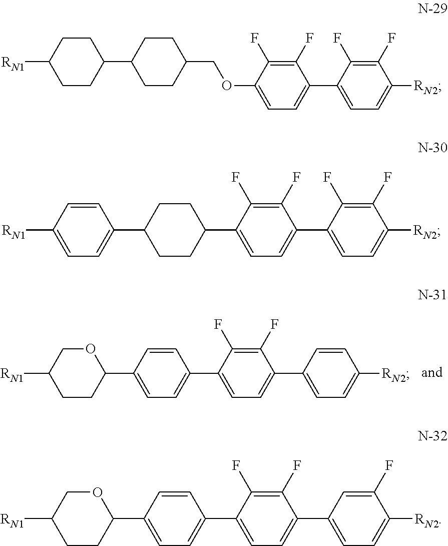

7. The liquid crystal composition according to claim 5, wherein the liquid crystal composition further comprises at least one compound of general formula M: 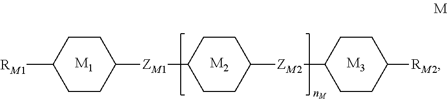
wherein,
R_{M1} and R_{M2} each independently represents C₁₋₁₂ linear alkyl, C₃₋₁₂ branched alkyl, 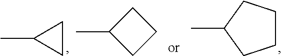
wherein one or more than two nonadjacent —CH₂— in the C₁₋₁₂ linear alkyl or C₃₋₁₂ branched alkyl can each be independently replaced by —CH═CH—, —C≡C—, —O—, —CO—, —CO—O— or —O—CO—;
ring 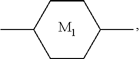
ring 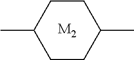
and ring 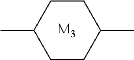
each independently represents 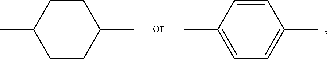
wherein one or more —CH₂— in 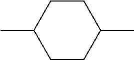
can be replaced by —O—, one or at most two single bonds in the ring can be replaced by double bond, at most one —H on 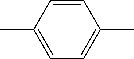
can be substituted by halo;
Z_{M1} and Z_{M2} each independently represents single bond, —CO—O—, —O—CO—, —CH₂O—, —OCH₂—, —C≡C—, —CH═CH—, —CH₂CH₂— or —(CH₂)₄—; and
n_{M} represents 0, 1 or 2, wherein when n_{M}=2, ring 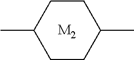
can be the same or different, Z_{M2} can be the same or different.

8. The liquid crystal composition according to claim 7, wherein the compound of general formula M is selected from a group consisting of the following compounds:

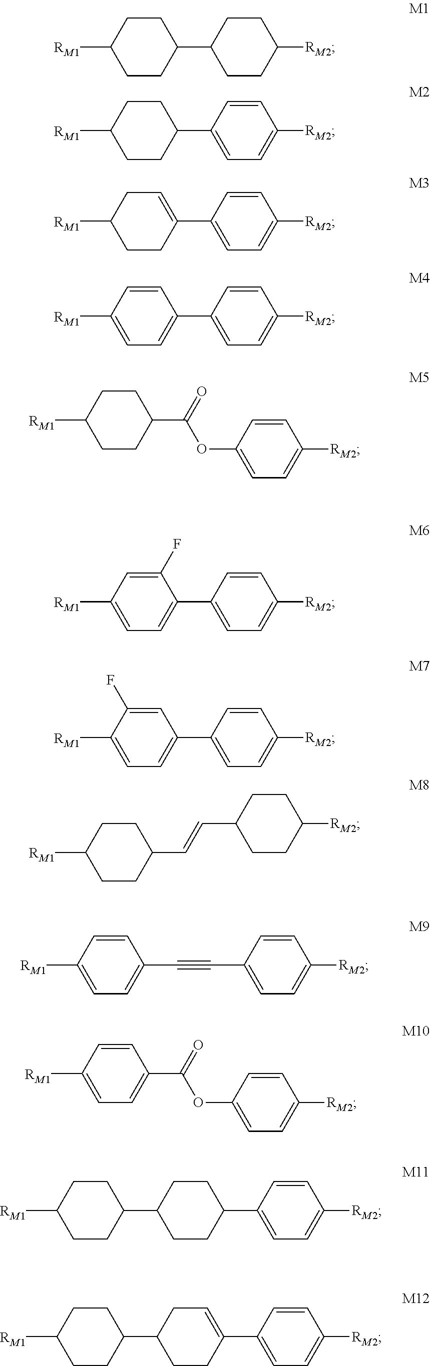

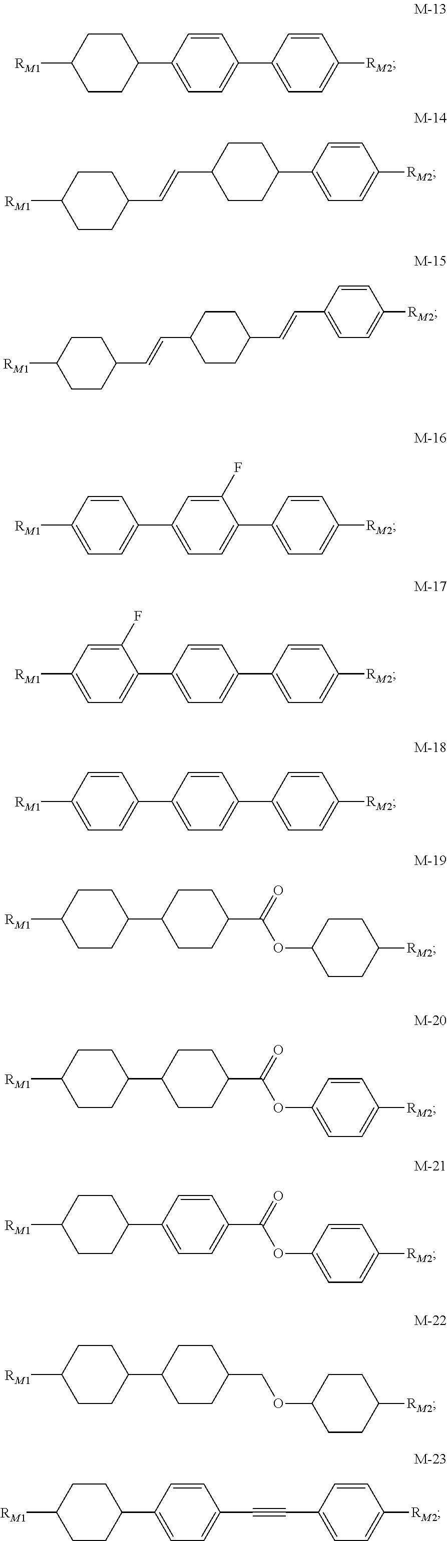

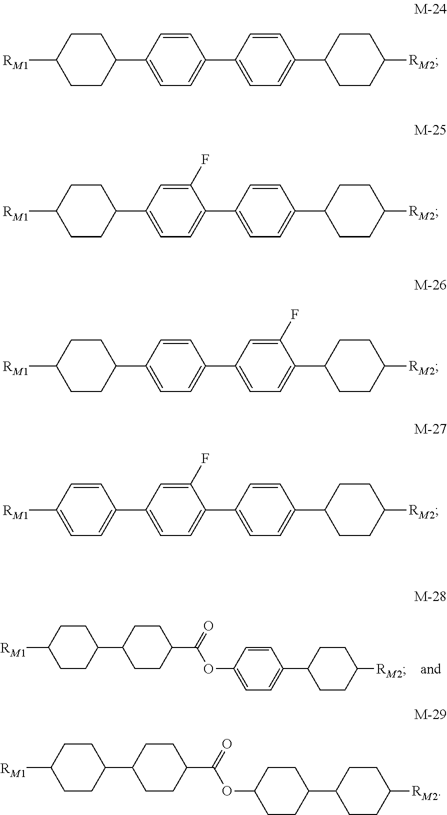

9. The liquid crystal composition according to claim 3, wherein the compound of general formula P comprises at least one compound of general formula P-1; the compound of general formula B comprises at least one compound of general formula B-5 and/or general formula B-11; the compound of general formula C is selected from a group consisting of the compound of general formula C-1, the compound of general formula C₄, the compound of general formula C-8 and the compound of general formula C-11.

10. The liquid crystal composition according to claim 7, wherein the compound of general formula N provides 0.1%-40% by weight of the liquid crystal composition; and the compound of general formula M provides 0.1%-70% by weight of the liquid crystal composition.

11. The liquid crystal composition according to claim 1, wherein the liquid crystal composition comprises at least one polymerizable compound of general formula RM: 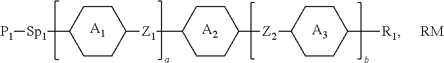
wherein,
R₁ represents —H, halo, —CN, -Sp₂-P₂, C₁₋₁₂ linear alkyl, C₃₋₁₂ branched alkyl, 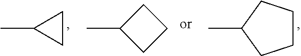
wherein one or more than two nonadjacent —CH₂— in the C₁₋₁₂ linear alkyl, C₃₋₁₂ branched alkyl, 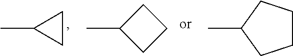
can each be independently replaced by —CH═CH—, —C≡C—, —O—, —CO—, —CO—O— or —O—CO—, and one or more —H can each be independently substituted by —F or —Cl;
ring 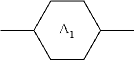
and ring 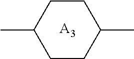
each independently represents 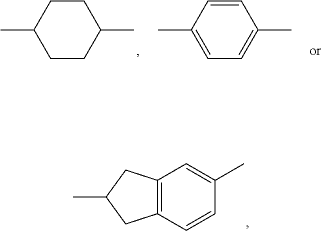
wherein one or more —CH₂— in 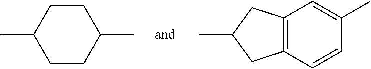
can be replaced by —O—, and one or at most two single bonds in the rings can be replaced by double bond, wherein one or more —H on 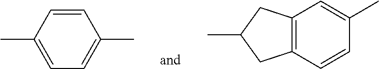
and each be independently substituted by —F, —Cl, —CN, -Sp₃-P₃, C₁₋₁₂ halogenated or unhalogenated linear alkyl, C₁₋₁₁ halogenated or unhalogenated linear alkoxy, 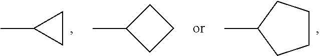
and one or more —CH═ in the rings can be replaced by —N═;
ring 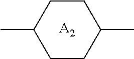
represents 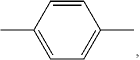
wherein one or more —H on 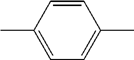
can each be independently substituted by —F, —Cl, —CN, -Sp₃-P₃, C₁₋₆ halogenated or unhalogenated linear alkyl, C₁₋₅ halogenated or unhalogenated linear alkoxy, 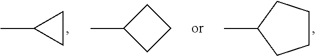
and one or more —CH═ in the ring can be replaced by —N═;
P₁, P₂ and P₃ each independently represents polymerizable group;
Sp₁, Sp₂ and Sp₃ each independently represents spacer group or single bond;
Z₁ and Z₂ each independently represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF=CF—, —CH═CF—, —CF=CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ linear alkyl, and d represents an integer of 1-4; and
a represents 0, 1 or 2, b represents 0 or 1, wherein when a represents 2, ring 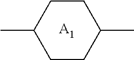
can be the same or different, and Z₁ can be the same or different.

12. A liquid crystal display device comprising the liquid crystal composition of claim 1.
